(19) United States
(12) Patent Application Publication
(10) Pub. No.: US 2026/0098995 A1
(43) Pub. Date: Apr. 9, 2026

(54) MULTILAYER STRUCTURE HAVING A MELT EXTRUDED WATER ABSORBING POLYOLEFIN LAYER

(71) Applicant: PolyChem Alloy, Inc., Lenoir, NC (US)

(72) Inventors: Chakra V. GUPTA, Lenoir, NC (US); Ashton Ray BARLOW, Lenoir, NC (US)

(73) Assignee: PolyChem Alloy, Inc., Lenior, NC (US)

(21) Appl. No.: 19/293,973

(22) Filed: Aug. 7, 2025

Related U.S. Application Data
(60) Provisional application No. 63/702,810, filed on Oct. 3, 2024.
(60) Provisional application No. 63/824,566, filed on Jun. 16, 2025.

(51) Int. Cl. G02B 6/02; B32B 1/08; B32B 27/08; B32B 27/32

(52) U.S. Cl. CPC G02B 6/02033; B32B 1/08; B32B 27/08; B32B 27/32; G02B 6/02333; G02B 6/02338; B32B 2250/02; B32B 2264/02; B32B 2307/726; B32B 2551/00

(57) ABSTRACT

A multilayer structure having a polyolefin layer and a water-absorbing layer is provided. The multilayer structure may be in the form of a tubular structure and is particularly useful in optical fiber applications. A system and method for preparing micronized polymer pellets is also provided. The micronized polymer pellets include a polymer resin and particles comprising a superabsorbent polymer.

### CROSS-REFERENCE TO RELATED APPLICATION

The present application claims priority of U.S. Provisional Application No. U.S. Provisional Application No. 63/824,566, filed Jun. 16, 2025 and 63/702,810, filed Oct. 3, 2024, the contents of which are hereby incorporated by reference.

### FIELD

The disclosure relates generally multilayer structures, and in particular, multilayer structures having water absorbing properties.

### BACKGROUND

Fiber optic cables generally include an internal space in which is disposed an optic fiber. The performance of optic fibers may be degraded by the intrusion of water into the fiber optic cable. To address this problem, water blocking materials, such as a petroleum based grease and water absorbing powders, such as talc or super absorbent polymer powders have been introduced into the fiber optic cables.

However, the use of water absorbing powders is undesirable due to the fine particle size of the powders, which results in the particles being airborne. This results in potential health hazards associated with use of powders as well as waste in materials.

Accordingly, there still exists a need to provide improved fiber optic cables and fibers for preventing water intrusion.

### SUMMARY

One or more embodiments of the disclosure may help to provide a solution to the aforementioned problems.

In certain embodiments, the disclosure provides a water-absorbing polymeric composition comprising a blend of a polyolefin resin and a plurality of micronized super absorbent polymer particles that are distributed within the polyolefin resin. In some embodiments, the plurality of micronized super absorbent polymer particles are homogeneously blended within the polyolefin resin. In certain embodiments, the plurality of micronized super absorbent polymer particles may be heterogeneously blended within the polyolefin resin.

In certain embodiments, the polymeric composition comprising the blend of a polyolefin resin and a plurality of micronized super absorbent polymer particles is provided in a pellet form, which may be melt extrudable to form a polymeric layer, polymeric coating, or polymeric molded article.

In certain embodiments, the water-absorbing polymeric composition comprising the blend of a polyolefin resin and a plurality of micronized super absorbent polymer particles may be extruded as a single polymer layer onto a substrate.

In certain embodiments, the water-absorbing polymeric composition comprising the blend of a polyolefin resin and a plurality of micronized super absorbent polymer particles may be coextruded with one or more polymer layers.

In one aspect, the disclosure provides a multilayer structure comprising a substrate and a water absorbing polyolefin layer comprising a super absorbent polymer. The water absorbing polyolefin layer comprises a blend of a polyolefin and micronized super absorbent polymer particles.

Advantageously, the water-absorbing polyolefin layer can be extruded directly and/or indirectly onto a surface of the substrate or coextruded in tandem with a polymeric substrate to form a multilayer structure having a water absorbing polyolefin layer.

In certain embodiments, the substrate comprises a polymeric material, such as film, foam, nonwoven, or the like. In some embodiments, the substrate may comprises a cylindrical shaped rod

In certain embodiments, aspects of the disclosure are directed to a multilayer structure comprising a polyolefin-based layer and a water-absorbing polyolefin layer. The multilayer structure may have a variety of shapes, such as comprising a film or a structure having a tube like shape.

In certain embodiments, the water-absorbing polyolefin layer comprises super absorbent polymer particles, the super absorbent particles having an average particle size from about 20 to 550 μm, such as from about 45 to 400 μm or about 20 to 100 μm.

In certain embodiments, an amount of super absorbent particles in the water-absorbing polyolefin layer is from about 0.05 to 20 weight percent, based on the total weight of the water-absorbing polyolefin layer. For example, the amount of super absorbent particles in the water-absorbing polyolefin layer may be from about 2 to 10 weight percent, based on the total weight of the water-absorbing polyolefin layer.

In certain embodiments, a ratio of the thickness of the polyolefin-based layer to a thickness of the water-absorbing polyolefin layer is from 95:5 to 75:25.

In certain embodiments, the polyolefin-based layer and the water-absorbing polyolefin layer comprises a polyolefin selected from the group consisting of polyethylenes (e.g., ultra low density, very low density, low-density, medium density, and high density), polypropylenes, polybutenes, ethylene vinyl acetate, and ethylene propylene copolymers and copolymers, derivatives, and blends thereof.

In certain embodiments, the polyolefin-based layer comprises polypropylene.

In certain embodiments, the water-absorbing polyolefin layer comprises polypropylene.

In certain embodiments, the polyolefin-based layer and the water-absorbing layer comprises the same polyolefin polymer.

Certain aspects of the invention are directed to an optical fiber comprising a fiber optic core, a cladding surrounding the core, and a multilayer structure concentrically surrounding the cladding, the multilayer structure comprising a polyolefin-based layer and a water-absorbing polyolefin layer.

In certain embodiments of the optical fiber, the polyolefin-based layer and the water-absorbing polyolefin layer are coextruded.

In certain embodiments of the optical fiber, the water-absorbing polyolefin layer comprises super absorbent polymer particles, the super absorbent particles having an average particle size from about 20 to 550 μm, such as from about 45 to 400 μm or from about 20 to 100 μm.

In certain embodiments of the optical fiber, the amount of super absorbent particles in the water-absorbing polyolefin layer is from about 0.05 to 20 weight percent, based on the total weight of the water-absorbing polyolefin layer.

In certain embodiments of the optical fiber, the amount of super absorbent particles in the water-absorbing polyolefin layer is from about 2 to 10 weight percent, based on the total weight of the water-absorbing polyolefin layer.

In certain embodiments of the optical fiber, a ratio of the thickness of the polyolefin-based layer to a thickness of the water-absorbing polyolefin layer is from 95:5 to 75:25.

In certain embodiments of the optical fiber, the polyolefin-based layer and the water-absorbing polyolefin layer comprises a polyolefin selected from the group consisting of polyethylenes (e.g., ultra low density, very low density, low-density, medium density, and high density), polypropylenes, polybutenes, ethylene vinyl acetate, and ethylene propylene copolymers and copolymers, derivatives, and blends thereof.

In certain embodiments of the optical fiber, the polyolefin-based layer comprises polypropylene.

In certain embodiments of the optical fiber, the water-absorbing polyolefin layer comprises polypropylene.

In certain embodiments of the optical fiber, the polyolefin-based layer and the water-absorbing layer comprises the same polyolefin polymer.

Certain embodiments of the disclosure provide an optic fiber cable comprising an outer longitudinally extending jacket defining a core; a buffer tube disposed in said core, the buffer tube comprising a multilayer structure having an annular shape defining a longitudinally extending conduit, the multilayer structure comprising a polyolefin-based layer and a water-absorbing polyolefin layer; and an optical fiber disposed in said conduit.

In certain embodiments of the optic fiber cable, the core comprises a plurality of said buffer tubes disposed therein.

In certain embodiments of the optic fiber cable, the polyolefin-based layer and a water-absorbing polyolefin layer of the multilayer structure are coextruded.

In certain embodiments of the optic fiber cable, the wherein the water-absorbing polyolefin layer comprises super absorbent polymer particles, the super absorbent particles having an average particle size from about 20 to 550 μm.

In certain embodiments of the optic fiber cable, the super absorbent particles having an average particle size from about 45 to 400 μm, such as from about 20 to 100 μm.

In certain embodiments of the optic fiber cable, an amount of super absorbent particles in the water-absorbing polyolefin layer is from about 0.05 to 20 weight percent, based on the total weight of the water-absorbing polyolefin layer.

In certain embodiments of the optic fiber cable, the amount of super absorbent particles in the water-absorbing polyolefin layer is from about 2 to 10 weight percent, based on the total weight of the water-absorbing polyolefin layer.

In certain embodiments of the optic fiber cable, a ratio of the thickness of the polyolefin-based layer to a thickness of the water-absorbing polyolefin layer of the multilayer structure is from 95:5 to 75:25.

In certain embodiments of the optic fiber cable, the polyolefin-based layer and the water-absorbing polyolefin layer of the multilayer structure comprises a polyolefin selected from the group consisting of polyethylenes (e.g., ultra low density, very low density, low-density, medium density, and high density), polypropylenes, polybutenes, ethylene vinyl acetate, and ethylene propylene copolymers and copolymers, derivatives, and blends thereof.

In certain embodiments of the optic fiber cable, the polyolefin-based layer of the multilayer structure comprises polypropylene.

In certain embodiments of the optic fiber cable, the water-absorbing polyolefin layer of the multilayer structure comprises polypropylene.

In certain embodiments of the optic fiber cable, the polyolefin-based layer and the water-absorbing layer of the multilayer structure comprises the same polyolefin.

In certain embodiments of the optic fiber cable, the buffer tube comprises a plurality of optical fibers disposed is said conduit.

In certain embodiments of the optic fiber cable, the buffer tube comprises from 2 to 20, such as 2 to 12, optical fibers disposed in said conduit.

In certain embodiments of the optic fiber cable, the optical fiber comprises a fiber optic core, a cladding surrounding the core, and a multilayer structure concentrically surrounding the cladding, the multilayer structure of the optical fiber comprising a polyolefin-based layer and a water-absorbing polyolefin layer.

In certain embodiments of the optic fiber cable, the polyolefin-based layer and a water-absorbing polyolefin layer of the multilayer structure of the optical fiber are coextruded, and wherein the water-absorbing polyolefin layer comprises super absorbent polymer particles, the super absorbent particles having an average particle size from about 20 to 550 μm.

In certain embodiments of the optic fiber cable, the super absorbent particles of the water-absorbing polymer of the optical fiber have an average particle size from about 45 to 400 μm.

In certain embodiments of the optic fiber cable, a ratio of the thickness of the polyolefin-based layer of the optical fiber to a thickness of the water-absorbing polyolefin layer of the of the optical fiber is from 95:5 to 75:25.

In certain embodiments of the optic fiber cable, the polyolefin-based layer of the optical fiber has a thickness from about 70 to 190 μm, and the water-absorbing polyolefin layer of the of the optical fiber has a thickness that is from 35 to 120 μm.

In additional aspect of the disclosure, a method of preparing micronized polymer pellets is provided.

In certain embodiments, the method of preparing micronized polymer pellets comprises
mixing a polymer resin and a plurality of particles comprising a micronized superabsorbent polymer to form a homogeneous polymer mixture;
introducing the polymer mixture into an extruder;
melting and kneading the polymer mixture in the extruder to form a molten or semi-molten polymer stream;
introducing the polymer stream into a melt pump;
measuring the pressure of the polymer stream exiting the melt pump;
adjusting the pressure of the polymer stream as it exits the melt pump to a predetermined pressure threshold for the polymer stream;
introducing the polymer stream into a pellet die, said pellet die comprising a plurality of fluid channels and corresponding extrusion orifices, the extrusion orifices having diameters ranging from about 0.020 to 0.050 mm;
dividing the polymer stream to flow through the plurality of fluid channels to form a plurality of polymer strands;
extruding the plurality of polymer strands through said extrusion orifices,
cutting the plurality of polymer strands to form a plurality of micronized polymer pellets; and
drying and collecting the micronized polymer pellets.

In certain embodiments, the plurality of micronized polymer pellets prepared in accordance with the method may be characterized by having an average particle size ranging from 400 to 500 μm with a standard deviation of less than 50 μm.

In certain embodiments of the method, the step of adjusting the pressure of the polymer stream comprises measuring a pressure of the polymer stream prior to introducing the polymer stream into the melt pump and then adjusting an operational speed of the melt pump to increase the pressure of the polymer stream to the predetermined pressure threshold

In certain embodiments of the method, the predetermined pressure threshold is stored in a computer (e.g., a PLC) having a memory storage device comprising executable program code, the executable program code being configured to instruct the melt pump to adjust the operational speed of the melt pump to achieve the predetermined pressure threshold for the polymer stream.

In certain embodiments of the method, the step of cutting the plurality of polymer strands to form a plurality of micronized polymer pellets is performed within a water bath, the water bath comprising a stream of heated water that is heated to a temperature ranging from about 70 to 90° C., such as from about 78 to 86° C.

In certain embodiments of the method, the steam of heated water collects the plurality of micronized polymer pellets and carries the plurality of micronized polymer pellets to a dryer unit, such as a centrifugal dryer.

In certain embodiments of the method, the polymer resin comprises a polyolefin, such as polyethylene, polypropylene, and blends thereof.

In certain embodiments of the method, the polyolefin is selected from the group consisting of linear low density polyethylene (LLDPE), low density polyethylene (LDPE), (mid density polyethylene (MDPE) and high density polyethylene (HDPE), and blends thereof.

In certain embodiments of the method, the polymer resin comprises a blend of a LLDPE and a HDPE. In some embodiments, the amount of LLDPE in the blend is from about 5 to 95 weight percent and the amount of HDPE in the blend is from about 5 to 95 weight percent, based on the total weight of the polymer composition.

In certain embodiments of the method, the polymer mixture may include one or more of an antioxidant, a styrene containing elastomer, and a UV stabilizer.

In certain embodiments of the method, the plurality of micronized polymer pellets exhibit an average particle size of less than 500 μm with a standard deviation of less than 50 μm.

In some embodiments of the method, the plurality of micronized polymer pellets are characterized by exhibiting an average particle size ranging from 300 to 500 μm, and in particular, from about 300 to 400 μm, with a standard deviation of less than 50 μm.

In certain embodiments of the method, the method comprises a step of rotomolding an article comprising the plurality of micronized polymer pellets.

In certain embodiments of the method, the step of adjusting the pressure of the polymer stream comprises increasing the pressure of the polymer stream by a factor at least 2.

In certain embodiments of the method, the step of adjusting the pressure of the polymer stream comprises increasing the pressure of the polymer stream by a factor ranging from 2 to 5.

In certain embodiments, an aspect of the disclosure is directed to a system for preparing micronized polymer pellets comprising a blend of polymer, such as a polyolefin, and a super absorbent polymer.

In certain embodiments of the system, the system comprises
a source of a polymer resin and a source of superabsorbent polymer particles;
an extruder in communication with the source of the polymer resin and the source of the superabsorbent polymer particles, the extruder being configured and arranged to melt knead the polymer resin and superabsorbent polymer particles to form a molten or semi-molten polymer stream;
a melt pump disposed downstream of the extruder and in fluid communication with the extruder, the melt pump having a proximal and distal end, the melt pump being configured to receive the polymer stream from the extruder and adjust a pressure of the polymer stream to a predetermined pressure threshold;
a die disposed downstream of the melt pump, the die comprising a plurality of fluid channels and a plurality of extrusion orifices each associated with a corresponding fluid channel, wherein the die is configured and arrange to distribute the polymer stream into a plurality of polymer strands; and
a pelletizer disposed downstream of the die, the pelletizer configured and arranged to cut the polymer strands to form a plurality of micronized polymer pellets.

In certain embodiments of the system, the system further comprises a pressure transducer disposed adjacent the distal end of the melt pump, the pressure transducer being configured and arranged to measure a pressure of the polymer stream as it exits the melt pump.

In certain embodiments of the system, a computer in communication with the pressure transducer and the melt pump, the computer comprising executable program code for providing instructions to the melt pump to increase or decrease operational speed of the melt pump to adjust the pressure of the polymer melt to the predetermined threshold.

In certain embodiments of the system, the system includes a water bath in which the extrusion orifices of the die are submerged in the water bath.

In certain embodiments of the system, the water bath comprises a heated water stream having a temperature from about 70 to 90° C., and wherein said heated water stream is in fluid communication with a dryer unit disposed downstream of the water bath, wherein the heated water stream collects the micronized polymer pellets in the water bath and transports them to the dryer unit.

### BRIEF DESCRIPTION OF THE SEVERAL DRAWINGS

Having thus described the invention in general terms, reference will now be made to the accompanying drawings, which are not necessarily drawn to scale, and wherein:

FIG. 1 illustrates a multilayer structure in accordance with at least one embodiment of the present disclosure;

FIGS. 2A-2C cross sections of the multilayer structure in which the multilayer structure has a tubular shape;

FIG. 3 illustrates a cross section of an optical fiber in accordance with certain embodiments of the disclosure;

FIG. 4 illustrates a cross section of a buffer tube in accordance with certain embodiments of the present disclosure;

FIG. 5 illustrates fiber optic cable in accordance with certain embodiments of the present disclosure; and

FIG. 6A is a cross section of a fiber optic cable in accordance with certain embodiments of the present disclosure;

FIG. 6B is a cross section of a cylindrical shaped strength member in accordance with certain embodiments of the present disclosure;

FIG. 7 illustrates a schematic drawing of a system for the preparation of polymer micropellets in accordance with at least one aspect of the disclosure; and

FIG. 8 illustrates a buffer tube in accordance with at least one aspect of the disclosure.

### DETAILED DESCRIPTION

The invention now will be described more fully hereinafter with reference to the accompanying drawings, in which some, but not all embodiments of the inventions are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

The terms “first,” “second,” and the like, “primary,” “exemplary,” “secondary,” and the like, do not denote any order, quantity, or importance, but rather are used to distinguish one element from another. Further, the terms “a,” “an,” and “the” do not denote a limitation of quantity, but rather denote the presence of “at least one” of the referenced item.

Each embodiment disclosed herein is contemplated as being applicable to each of the other disclosed embodiments. All combinations and sub-combinations of the various elements described herein are within the scope of the invention.

It is understood that where a parameter range is provided, all integers within that range, and tenths and hundredths thereof, are also provided by the invention. For example, “5-10%” includes 5%, 6%, 7%, 8%, 9%, and 10%; 5.0%, 5.1%, 5.2% . . . 9.8%, 9.9%, and 10.0%; and 5.00%, 5.01%, 5.02% . . . 9.98%, 9.99%, and 10.00%.

As used herein, the terms “about.” “approximately.” and “substantially” in the context of a numerical value or range means ±10% of the numerical value or range recited or claimed, and in particular, encompasses values within a standard margin of error of measurement (e.g., SEM) of a stated value or variations ±0.59%, 1%, 5%, or 10% from a specified value.

For the purposes of the present application, the following terms shall have the following meanings:

As used herein, and unless indicated to the contrary, the term “molecular weight” refers to the weight average molecular weight (Mw), and is expressed in grams/mol. The weight average molecular weight can be determined using commonly known techniques, such as gel permeation chromatography (GPC).

As used herein the term “polymer” generally includes, but is not limited to, homopolymers, copolymers, such as, for example, block, graft, random and alternating copolymers, terpolymers, etc. and blends and modifications thereof. Furthermore, unless otherwise specifically limited, the term “polymer” shall include all possible geometrical configurations of the material, including isotactic, syndiotactic and random symmetries.

The present disclosure relates to a multilayer polymer structure having a polyolefin-based layer and a water absorbing polyolefin-based layer. The multilayer structure can contain two or more layers, and can be made by any method known to the art. In certain embodiments, the multilayer structure is made via coextrusion of the polyolefin-based layer and the water absorbing polyolefin-based layer. The multilayer structure can have any given geometry, including but not limited to, a tubular shape, a flat sheet, a rod, a profile, or the like. The multilayer structure exhibits excellent structural integrity, excellent surface appearance, high impact strength, high scratch resistance, and excellent resistance to moisture penetration.

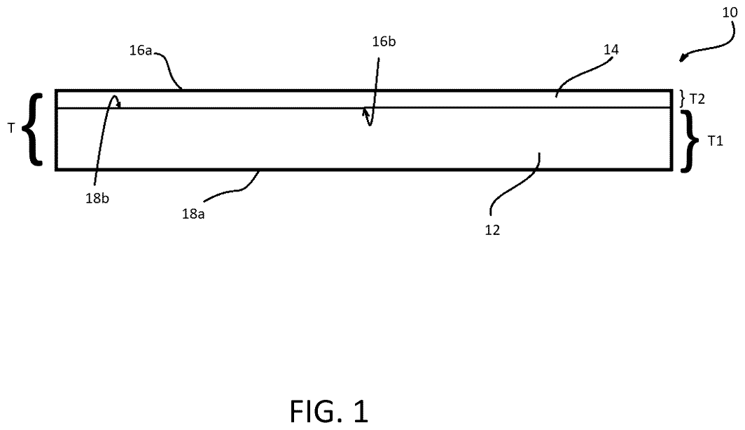

With reference to FIG. 1, a multilayer structure in accordance with at least one or more embodiments of the present disclosure is provided and designated by reference character 10. Multilayer structure 10 depicted in FIG. 1 includes a polyolefin-based layer 12 (also referred to as a substrate layer) and a water absorbing polyolefin layer 14 disposed overlying the substrate layer 12. The polyolefin-based layer 12 includes a first surface 18a and a second surface 18b. Similarly, the water-absorbing polyolefin layer includes a first surface 16a and a second surface 16b.

In certain embodiments, the second surface 18b of the polyolefin-based layer 12 is disposed opposite the second surface 16b of the water-absorbing polyolefin layer 14. The polyolefin-based layer 12 may be joined directly to the water-absorbing polyolefin layer 14 at the interfaces the second surfaces 16b, 18b of each respective layer. In certain other embodiments, the multilayer structure may include one or more intermediate layers (not shown) that are disposed between the polyolefin-based layer 12 and the water-absorbing polyolefin layer 14. For example, the multilayer structure 10 may include various functional layers, such as an adhesive layer or tie layer that is disposed between the polyolefin-based layer 12 and the water-absorbing polyolefin layer 14.

In a preferred embodiment, the polyolefin-based layer 12 and the water-absorbing polyolefin layer 14 are prepared in a coextrusion process and are joined in direct contact with each other. In certain embodiments, the multilayer structure comprises a multilayer polymeric film.

The multilayer structure has a thickness (“T”) comprising the combined thickness of the polyolefin-based layer (T1) and the water absorbing polyolefin layer (T2). Typically, the thickness T of multilayer structure is from 0.10 to 2 mm and in particular, from about 0.5 to 1.5 mm, and more particularly, from about 0.8 to 1.25 mm.

In certain embodiments, a ratio of the thickness of the polyolefin-based layer to a thickness of the water-absorbing polyolefin layer is from 95:5 to 75:25.

Typically, the polyolefin-based layer has a greater thickness than that of the water absorbing polyolefin layer.

### Polyolefin-Based Layer

Generally, the polyolefin-based layer comprises the major component of the multilayer structure 10. The polyolefin-based layer may comprise a single layer or may be comprised of multiple layers, such as from about 2-10, and more particularly, 2 to 4 layers. In embodiments in which the polyolefin-based layer comprises two or more layers, the other layers may provide functional properties. Such properties may include moisture and gas barrier properties, oxygen scavenging properties, adhesive properties, mechanical properties, such as improvements in strength and/or elongation.

The polyolefins employed may comprise semicrystalline or crystallizable olefin polymers, which may include homopolymers, copolymers, terpolymers, or mixtures thereof, etc., containing one or more olefin monomeric units. In the polyolefin-based layer, the polyolefins are generally present in an amount from 50 to 100% by weight, preferably at least 75%, and more preferably at least 90% by weight.

In certain embodiments, polymers of alpha-olefins or 1-olefins may be used in embodiments of the present invention. In some embodiments, the alpha-olefins may contain from 2 to about 20 carbon atoms, such as alpha-olefins containing 2 to about 6 carbon atoms are preferred. In certain embodiments, the olefin polymers may be derived from olefins such as ethylene, propylene, 1-butene, 1-pentene, 4-methyl-1-pentene, 1-octene, 1-decene, 4-ethyl-1-hexene, etc.

Suitable materials for the polyolefin-based layer may include polyethylenes (e.g., ultra low density, very low density, low-density, medium density, and high density), polypropylenes, polybutenes, and copolymers, derivatives, and blends thereof. In certain embodiments, preferred polyolefins may include polypropylene, polyethylene, polybutylene, ethylene vinyl acetate, and ethylene propylene copolymers with polypropylene being somewhat more preferred.

In certain embodiments, the polyolefin of the polyolefin-based layer consists of polypropylene. In some embodiments, suitable polyolefins may include polypropylene and ethylene-propylene polymers. Propylene polymers may be semi-crystalline or crystalline in structure. The number average molecular weight of the propylene polymers is preferably above about 10,000 and more preferably above about 50,000 as measured by gel permeation chromatography. In addition, it is preferred in one embodiment that the apparent crystalline melting point be above about 75° C. and preferably between about 75° C. and about 250° C. The propylene polymers useful in the present invention are well-known to those skilled in the art and many are available commercially.

In certain embodiments, suitable polyolefin resins include impact polypropylenes comprised of propylene and ethylene monomers. Examples of suitable impact polypropylenes include those available from INVISTA™ under the product code P6G4A-136 (having a melt flow rate of 5.5 g/10 min. at 230° C., a density of 0.90 g/cm³, and a melting temperature of 160-165° C.); and INEOS under the product code N05U-00) (having a melt flow rate of 5.0 g/10 min. at 230° C., and a density of 0.907 g/cm³). Unless otherwise stated, melt flow rate is measured in accordance with ASTM D1238; density is measured in accordance with ASTM D1505, and melting temperature is measured in accordance with ASTM D3418.

One or more of the layers of the multilayer structure of the present disclosure may contain any of the additives conventionally employed in the manufacture of multilayer polymeric structures. For example, agents such as pigments, lubricants, antioxidants, radical scavengers, UV absorbers, thermal stabilizers, anti-blocking agents, surface active agents, slip aids, optical brighteners, gloss improvers, viscosity modifiers may be incorporated as appropriate.

In certain embodiments, the additives may be added in the form of a concentrate in a carrier master batch resin.

### Water-Absorbing Polyolefin Layer

The water-absorbing polyolefin layer comprises a polymeric blend of a polyolefin polymer and a micronized super absorbent polymer particles. Suitable polyolefin polymers are discussed previously in connection with the polyolefin-based layer.

In certain embodiments, any super absorbent polymer that is capable of being micronized and does not degrade under extrusion conditions may be used in the polymeric blend comprising the super absorbent polymer (SAP) and the polyolefin polymer.

Advantageously, the polymeric blend of the water-absorbing polymer layer is cable of being melt extruded to form the water-absorbing layer. The water-absorbing layer may be melt extruded directly or indirectly onto a surface of the polyolefin-based layer. In certain embodiments, the polyolefin-based layer and the water-absorbing layer are coextruded to form the multilayer structure.

In certain embodiments, the polyolefin and the micronized super absorbent polymer particles of the water-absorbing polyolefin layer are preblended to form a homogeneous blend that is then extruded to form the water-absorbing polyolefin layer. In other embodiments, the micronized super absorbent polymer particles are separately added to the extruder, which is then melt extruded to form a polymeric blend comprising the micronized super absorbent polymer particles and the polyolefin. The micronized super absorbent polymer particles may be homogeneously or heterogeneously blended with the polyolefin. In certain embodiments, the micronized super absorbent polymer particles and polyolefin are homogeneously blended.

In certain embodiments, the super absorbent polymer (SAP) comprises an acrylic acid copolymer having high water absorbency and retention properties. For example, the SAP particles may have a water absorbency of at least 300 g/g (measured in accordance with JIS K 7223), and in particular, at least 400 g/g, and more particularly 500 g/g, and even more particularly, at least 600 g/g, such as at least 650 g/g, at least 700 g/g, at least 750 g/g, and at least 800 g/g.

Examples of suitable SAP particles that may be used in certain embodiments of the invention include salts (e.g., Na, K, NH₃) of cross-linked acrylic acid polymer and starch acrylic acid graft copolymers. In certain embodiments, the SAP comprises an acrylate styrene copolymer. A commercially available SAP is available from Sanyo Chemical Industries under the product name SANFRESH (product code ST 500D). A further example of a commercially available SAP is available from SUMITOMO SEIKA under the product name AQUA KEEP (product code CA 180N).

In certain embodiments, the micronized super absorbent polymer (SAP) comprises a plurality of particles having an average particle diameter greater than 20 μm, and in particular, greater than 50 μm, and more particularly, greater than 60 μm, and even more particularly, greater than 65 μm. In certain embodiments, the SAP particles have an average particle diameter ranging from about 20 to 550 μm, and in particular, from about 30 to 450 μm, and more particularly, from about 45 to 400 μm. In some embodiments, the SAP particles have an average particle diameter ranging from about 50 to 390 μm. In particular, embodiments, the SAP particles have an average particle diameter ranging from about 20 to 100 μm, and in particular, from about 30 to 90 μm, and more particularly from about 50 to 80 μm.

In certain embodiments, the micronized super absorbent polymer (SAP) comprises a plurality of particles having an average particle diameter greater than 200 μm, and in particular, greater than 250 μm, and more particularly, greater than 300 μm, and even more particularly, greater than 350 μm. In certain embodiments, the SAP particles have an average particle diameter ranging from about 250 to 550 μm, and in particular, from about 300 to 450 μm, and more particularly, from about 350 to 400 μm. In some embodiments, the SAP particles have an average particle diameter ranging from about 370 to 390 μm.

In one embodiment, the SAP particles have an average particle diameter of at least 250 μm, at least 260 μm, at least 270 μm, at least 275 μm, at least 280 μm, at least 290 μm, at least 300 μm, at least 310 μm, at least 320 μm, at least 330 μm, at least 340 μm, at least 350 μm, at least 360 μm, at least 370 μm, at least 380 μm, at least 390 μm, at least 400 μm, at least 410 μm, at least 420 μm, at least 430 μm, at least 440 μm, at least 450 μm, at least 460 μm, at least 470 μm, at least 480 μm, at least 490 μm, at least 500 μm, at least 510 μm, at least 520 μm, at least 530 μm, at least 540 μm.

In addition, the SAP particles may have an average particle diameter of less than 550 μm, less than 540 μm, less than 530 μm, less than 520 μm, less than 510 μm, less than 500 μm, less than 490 μm, less than 480 μm, less than 470 μm, less than 460 μm, less than 450 μm, less than 440 μm, less than 430 μm, less than 420 μm, less than 410 μm, less than 400 μm, less than 390 μm, less than 380 μm, less than 370 μm, less than 360 μm, less than 350 μm, less than 340 μm, less than 330 μm, less than 320 μm, less than 310 μm, less than 300 μm, less than 290 μm, less than 280 μm, less than 270 rows, and less than 260 μm.

The polyolefin polymer comprises the major component of the polymer blend.

Suitable polyolefins for use in the polymer blend are those discussed above with respect to the polyolefin-based layer.

The amount of the SAP particles in the polymer blend will generally depend on the final desired properties of the multilayer. In general, the amount of the SAP particles may range from about 5.0 weight percent to about 50 weight percent, based on the total weight of the polymer blend, and in particular, from about 5 to 20 weight percent, and more particularly, from about 5 to 10 weight percent, based on the total weight of the polymer blend.

In one embodiment, the amount of the SAP in the polymer blend may be at least about any one of the following: at least 0.05, at least 0.10, at least 0.2, at least 0.3, at least 0.4, at least 0.5, at least 0.6, at least 0.7, at least 0.8, at least 0.9, at least 1.0, at least 2.0, at least 3.0, at least 4.0 at least 5.0, at least 6.0, at least 7.0, at least 8.0, at least 9.0, at least 10.0, at least 11.0 at least 12.0, at least 13.0, at least 14.0, at least 15.0, at least 16.0, at least 17.0, at least 18.0, at least 19.0 and at least 20.0 weight percent, based on the total weight of the polymeric blend. In other embodiments, the amount of the SAP in the blend may be less than about any one of the following: 20.0, 19.0, 18.0, 17.0, 16.0, 15.0, 14.0, 13.0, 12.0, 11.0, 10.0, 9.0, 8.0, 7.0, 6.0, 5.0, 4.0, 3.0, 2.0, 1.0, and less than 0.5, weight percent, based on the total weight of the polymeric blend. It should also be recognized that the amount of the SAP particles present in a polymer blend also encompasses ranges between the aforementioned amounts.

In certain embodiments, the SAP particles may be provided in a masterbatch carrier resin. For example, in one embodiment, the SAP particles are provided in a polyolefin carrier resin that is blended with a polyolefin polymer prior to extruding a layer comprising the polymer blend of the polyolefin and the SAP particles. The masterbatch may also include additional additives, such as those mentioned previously. Alternatively, the SAP particles may be separately metered directly into the polyolefin polymer during the extrusion process.

### Representative Multilayer Structures

As discussed previously, multilayer structures in accordance with embodiments of the present disclosure may be used in a wide range of applications. Examples of such applications may include film sheets, molded articles, formed articles, foamed articles, coextruded articles, such as tubular structures, communication cables, electrical cables, and the like.

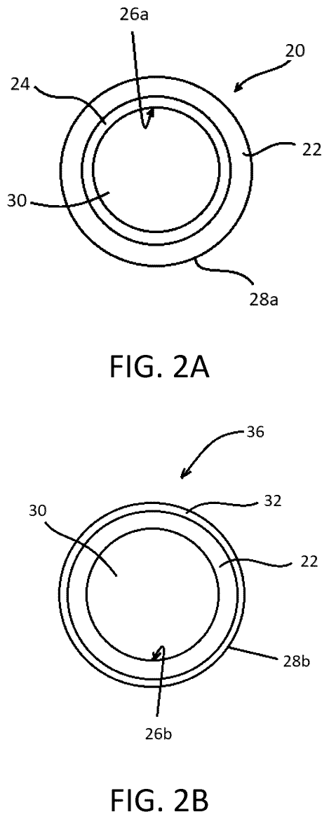

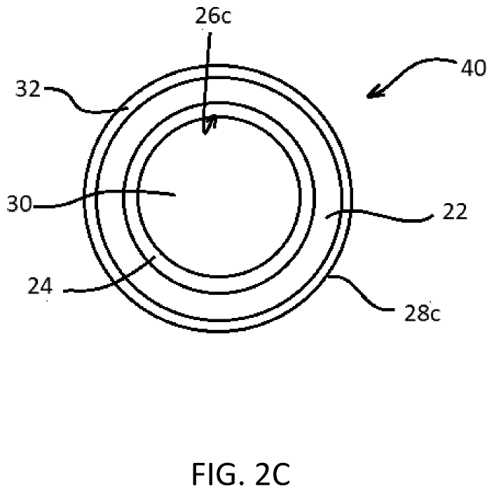

With reference to FIGS. 2A-2C, cross-sections of embodiments of a multilayer structure having a tubular shape are illustrated and designated by reference characters 20, 36, and 40, respectively (collectively referred to herein as a multilayer tubular structure). Multilayer tubular structures 20, 36, 40 each include a multilayer structure comprising a continuous annular shaped sidewall and a centrally disposed conduit 30 that each extend continuously along a length of the multilayer tubular structure. More specifically, the conduit 30 extends longitudinally along the length of the multilayer structure.

In certain embodiments, the conduit 30 may comprise one or more communication elements (e.g., one or more optical fiber cores, dielectric insulated wires or wire, and the like) that extend continuously along the length of the conduit.

As can be seen in FIG. 2A, embodiments of the multilayer tubular structure 20 includes a polyolefin-based layer 22 and a water-absorbing polyolefin layer 24. In this embodiment, water-absorbing polyolefin layer 24 defines an annular shaped inner layer and polyolefin-based layer 22 defines an annular shaped outer layer of the multilayer tubular structure 20.

In certain embodiments, an outer surface water-absorbing polyolefin layer 24 defines an inner surface 26a and an outer surface of the polyolefin-based layer 22 defines an outer surface of the multilayer tubular structure 20.

In the embodiment of FIG. 2B, a water-absorbing polyolefin layer 32 defines an outer annular shaped layer and polyolefin-based layer 22 defines an inner annular shaped layer of the multilayer tubular structure 36. Here, an outer surface of the water-absorbing polyolefin layer 32 defines an outer surface 28b and an outer surface of the polyolefin-based layer 22 defines an inner surface 26b of the multilayer tubular structure 36.

FIG. 2C illustrates an embodiment in which the polyolefin-based layer 22 is disposed between a pair of water absorbing polyolefin layers 32, 24. In this embodiment, water absorbing polyolefin layer 32 comprises an annular shaped layer defining an outer surface 28c of multilayer tubular structure. Similarly, water absorbing polyolefin layer 24 comprises an annular shaped layer defining an inner surface 26c of the multilayer tubular structure.

In certain embodiments, the multilayer structure may comprise a multilayer coextruded communication cable, such as an optical fiber, in which the multilayer structure is coextruded around an optical fiber core.

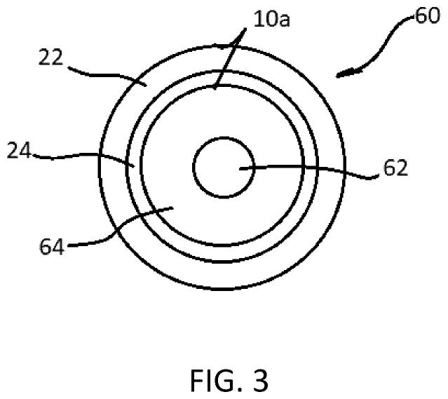

In this regard, FIG. 3 illustrates a cross section of an optical fiber 60 comprising a multilayer structure 10a in accordance with one or more embodiments of the present disclosure. The optical fiber comprises an optical fiber comprising an optical fiber core 62 concentrically surrounded by a cladding 64. In this illustrated embodiment, a single optical fiber core is shown concentrically surrounded by the multilayer structure 10a.

In certain embodiments, the optical fiber core 62 comprises a glass optical fiber. In some embodiments, the optical fiber core may comprise a polymeric material. The optical fiber core may be single mode optical fiber or a multi-mode optical fiber. Although not shown, the optical fiber core may comprise a plurality of optical fibers that are aligned and bound together in a fiber ribbon form.

The cladding comprises one or more layers of material that are of lower refractive index than the optical fiber core. Suitable materials for the cladding are known in the art.

As discussed previously, the multilayer structure 10a includes a polyolefin-based layer 22 and a water absorbing polyolefin layer 24. The water absorbing polyolefin comprises a blend of a micronized super absorbent polymer and a polyolefin polymer. Advantageously, the multilayer structure 10a is coextruded concentrically surrounding the cladding and optical fiber core to encapsulate the cladding and optical fiber core therein. The water absorbing polyolefin layer captures any moisture present within the optical cable which helps prevent cable degradation or failure of the optical cable.

In certain embodiments in which the multilayer structure 10a is directly or indirectly coextruded surrounding the optical fiber core, the thickness of the multilayer structure may range from 75 to 200 μm, and in particular, from about 80 to 160 μm, and more particularly, from about 90 to 120 μm. Typically, the polyolefin-based layer comprises the majority portion of the multilayer structure by weight and relative thickness. For example, the polyolefin-based layer typically has a thickness from about 70 to 190 μm, and in particular, 75 to 150 μm. Similarly, the water-absorbing polyolefin layer typically has a thickness from about 35 to 125 μm, and more typically, from about 60 to 100 μm, and more typically, from about 80 to 100 μm.

The weight percentage of the polyolefin-based layer to the water-absorbing layer is generally from about 50 to 95 weight percent, based on the total weight of the composite structure, and more generally from about 60 to 90 weight percent, and even more generally, from about 75 to 85 weight percent based on the total weight of the composite structure 10a.

The multilayer structure 10a may include multiple layers and may include multiple layers of the water absorbing polyolefin including configurations in which the polyolefin-based layer is sandwiched between a pair of water absorbing polyolefin layers, at least one water absorbing polyolefin layer comprises an inner surface of the multilayer structure, and at least water absorbing polyolefin layer comprises an outer surface of the multilayer structure (see previous discussion with respect to FIGS. 2A-2C). Although not shown in FIG. 3, the optical cable 60 may also include additional layers, such as one or more additional layers comprising an outer protective jacket.

As discussed below, certain embodiments of the disclosure may be readily adapted for use in commercially available optical cables, such as optical cables available from Commscope, Corning, and Southwire, and the like.

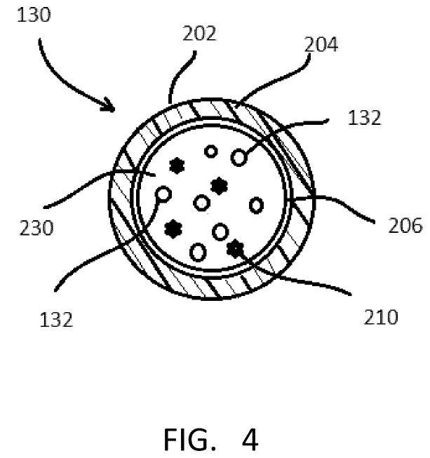

FIG. 4 shows a buffer tube 130 for use in an optical cable. In certain embodiments, the buffer tube 130 may comprise a core of an optic fiber cable. In certain embodiments, the buffer tube 130 may comprise a sub-unit of a optic fiber cable in which the core of the optic fiber cable comprises a plurality of buffer tubes arranged within a core of the optic fiber cable.

The buffer tube 130 comprises an annular shaped multilayer structure 202 having an internal conduit 230 that extends longitudinally along a length of the buffer tube 130. In certain embodiments, one or more optical fibers 132 extend longitudinally through the conduit 230. The buffer tube comprises multilayer structure 202 having a polyolefin-based layer 204 and a water absorbing polyolefin layer 206.

For example, the buffer tube may include from 1 to 30 optical fibers, such as from about 2 to 14, 3 to 13, 4 to 12, and 6 to 10. In certain embodiments, the optical fibers may be single mode optical fiber or a multi-mode optical fiber. In addition, the optical fibers may be aligned and bound together in a fiber ribbon form. In certain embodiments, the optical fibers may be arranged in pairs that are wound around each other, such as helically wound.

In some embodiments, the optical fibers 132 have similar structures to that described with respect to FIG. 3. For example, the optical fibers 132 may have an optical fiber core that is concentrically surrounded by a cladding, which in turn is concentrically by the multilayer structure having at least one polyolefin-based layer and at least one water absorbing polyolefin layer.

In certain embodiments, a thickness of the multilayer structure 202 comprising the buffer tube 130 may range from 0.15 to 0.5 mm, and in particular, from about 0.2 to 0.35 mm, and more particularly, from about 0.2 to 0.3 mm.

Typically, the polyolefin-based layer comprises the majority portion of the multilayer structure 202 by weight and relative thickness. For example, the polyolefin-based layer typically has a thickness from about 0.10 to 0.45 mm, and in particular, from 0.15 to 0.30 mm. Similarly, the water-absorbing polyolefin layer typically has a thickness from about 0.05 to 0.15 mm, and more typically, from about 0.08 to 0.2 mm, and more typically, from about 0.1 to 0.15 mm.

The weight percentage of the polyolefin-based layer 204 to the water-absorbing polyolefin layer 206 is generally from about 50 to 95 weight percent, based on the total weight of the composite structure, and more generally from about 60 to 90 weight percent, and even more generally, from about 75 to 85 weight percent based on the total weight of the composite structure 202.

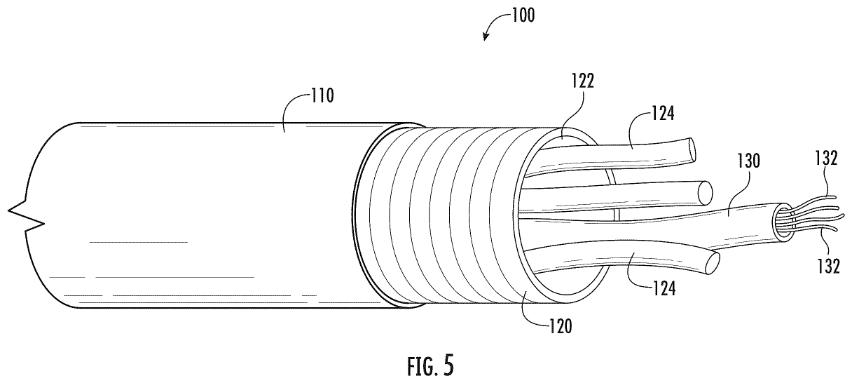

With reference to FIG. 5, a further embodiment of the present disclosure is illustrated. FIG. 5 shows a fiber optic cable 100 comprising an outer jacket 110 and an inner jacket 120 that collectively define a longitudinally extending conduit 122 that extends continuously along a length of the fiber optic cable 100.

The fiber optic cable further includes one or more tubes 130, such as a buffer tube, comprising a plurality of optical fibers disposed in conduit 122. The tube 130 has an annular shape defining a longitudinally extending conduit that extends continuously along a length of the tube 130.

In certain embodiments, the tube 130 is in accordance with multilayer tubular structure described in relation to any one or more of FIGS. 2A-2C. In particular, the tube 130 may comprise a multilayer structure having at least one polyolefin-based layer and at least one water-absorbing polyolefin layer.

In certain embodiments, the fiber optic cable may include one or more strength members 124 disposed in conduit 122. The strength members 124 may comprise a composite material, polymeric material, yarns, fibers, or combinations thereof.

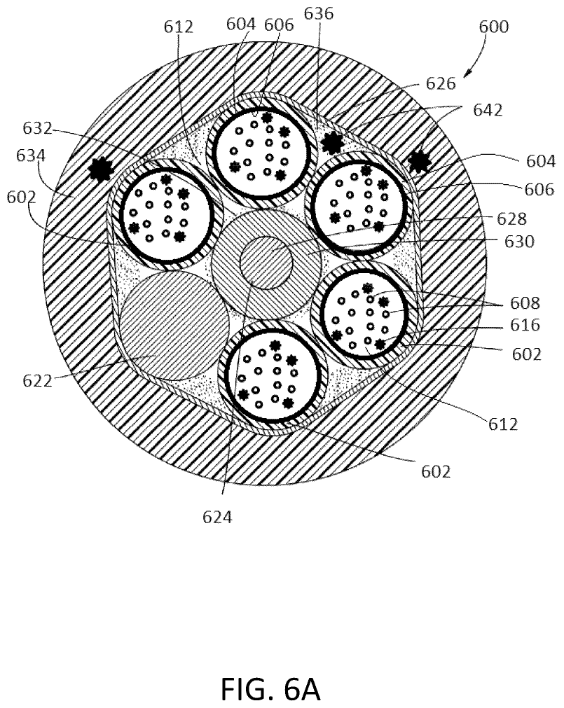

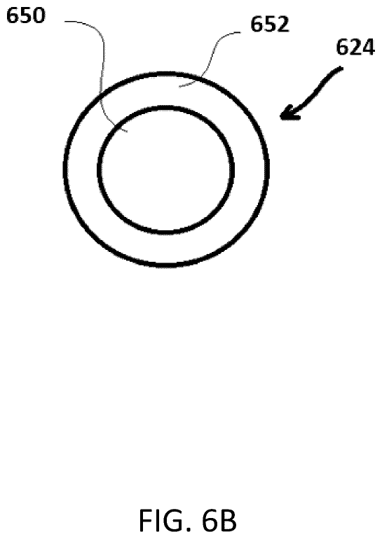

With reference to FIG. 6A, a fiber optic cable in accordance with certain embodiments of the invention is shown and designated by reference character 600. Fiber optic cable 600 is an improvement on a fiber optic cable design developed by Corning Incorporated and described in U.S. Pat. No. 8,620,124, the contents of which are hereby incorporated by reference.

Fiber optic cable 600 may be an outside-plant loose tube cable, an indoor cable with fire-resistant/retardant properties, an indoor/outdoor cable, or another type of cable, such as a datacenter interconnect cable with micro-modules or a hybrid fiber optic cable including conductive elements.

In certain embodiments, fiber optic cable 600 includes an outer jacket 634 defining a core 612 (e.g., sub-assembly, micro-module), which may be located in the center of the cable 600 or elsewhere and may be the only core of the cable 600 or one of several cores. According to an exemplary embodiment, the core 612 of the cable 600 includes core elements (see, e.g., reference characters 602, 624, 630, and 622).

In some embodiments, the core elements include a tube 602, such as a buffer tube surrounding at least one optical fiber 608. In certain embodiments, tube 602 comprises a coextruded multilayer structure having at least one polyolefin-based layer 604 and a least one water absorbing polyolefin layer 606. The multilayer structure of the tube 602 may be in accordance with the embodiment discussed previously, such as the embodiments of the multilayer structure described in relation to FIGS. 2A-2C.

According to an exemplary embodiment, the tube 602 may contain two, four, six, twelve, twenty-four or other numbers of optical fibers 608. The optical fibers 608 may comprise any optical fiber conventionally used in fiber optic cables. In certain embodiments, the optical fibers may comprise a multilayer structure having at least one polyolefin-based layer and a least one water-absorbing polyolefin layer, such as the embodiments of an optical fiber discussed previously in relation to FIG. 3.

In certain embodiments, the tube 602 may optionally include a water-blocking element, such as gel (e.g., grease, petroleum-based gel) or an absorbent polymer (e.g., super-absorbent polymer particles or powder). In some such embodiments, the tube 602 includes yarn 616 carrying (e.g., impregnated with) super-absorbent polymer, such as at least one water-blocking yarn 616, at least two such yarns, or at least four such yarns per tube 602.

According to an exemplary embodiment, the optical fiber 608 of the tube 602 is a glass optical fiber, having a fiber optic core surrounded by a cladding, such as shown in FIG. 3. Some such glass optical fibers may also include one or more polymeric coatings. The optical fiber 608 of the tube 602 is a single mode optical fiber in some embodiments, a multi-mode optical fiber in other embodiments, a multi-core optical fiber in still other embodiments. The optical fiber 608 may be bend resistant (e.g., bend insensitive optical fiber, such as CLEARCURVE™ optical fiber manufactured by Corning Incorporated of Corning, N.Y.). The optical fiber 608 may be color-coated and/or tight-buffered. The optical fiber 608 may be one of several optical fibers aligned and bound together in a fiber ribbon form.

In certain embodiments, the core 612 of the cable 600 includes a plurality of additional core elements (e.g., elongate elements extending lengthwise through the cable 600), in addition to the tube 602, such as at least three additional core elements, at least five additional core elements. According to an exemplary embodiment, the plurality of additional core elements includes one or more optional filler rods 622.

In other contemplated embodiments, the core elements may also or alternatively include straight or stranded conductive wires (e.g., copper or aluminum wires) or other elements. In some embodiments, the core elements are all about the same size and cross-sectional shape, such as all being round and having diameters of within 10% of the diameter of the largest of the core elements. In other embodiments, core elements may vary in size and/or shape.

In certain embodiments, the cable 600 includes an optional binder film 626 (e.g., membrane) surrounding the core 612, exterior to some or all of the core elements. The tube 602 and the plurality of additional core elements (e.g., 622) are at least partially constrained (i.e., held in place) and directly or indirectly bound to one another by the binder film 626. In some embodiments, the binder film 626 directly contacts the core elements. For example, tension in the binder film 626 may hold the core elements against a central strength member 624 and/or one another.

In certain embodiments, the binder film 626 includes (e.g., is formed from, is formed primarily from, has some amount of) a polymeric material such as polyethylene (e.g., low-density polyethylene, medium density polyethylene, high-density polyethylene), polypropylene, polyurethane, or other polymers. In some embodiments, the binder film 626 includes at least 70% by weight polyethylene, and may further include stabilizers, nucleation initiators, fillers, fire-retardant additives, reinforcement elements (e.g., chopped fiberglass fibers), and/or combinations of some or all such additional components or other components.

In certain embodiments, the cable 600 further includes the central strength member 624, which may be a dielectric strength member, such as an up-jacketed glass-reinforced composite rod. In other embodiments, the central strength member 624 may be or include a steel rod, stranded steel, tensile yarn or fibers (e.g., bundled aramid), fiberglass, or other strengthening materials. As shown in FIG. 6, the central strength member 624 may include a center rod 628 and is up jacketed with a polymeric material 630 (e.g., polyethylene, low-smoke zero-halogen polymer).

In certain embodiments, the central strength member 624 may include a water-absorbing polyolefin layer. In this regard, FIG. 6B shows an embodiment of a central strength member 624 having an inner core 650 (e.g., a glass-reinforced composite rod, a steel rod, stranded steel, tensile yarn or fibers (e.g., bundled aramid), fiberglass, or other suitable strengthening material that is concentrically surrounded by a water-absorbing layer 652 comprising a water-absorbing polyolefin composition. As in the previously discussed embodiments, the water-absorbing polyolefin composition comprises a blend of a polyolefin polymer and a plurality of micronized super absorbent polymer particles.

The water absorbing layer 652 may comprise a single layer or multiple additional layers. For example, in some embodiments, the water-absorbing layer consists of a single layer of the water-absorbing polyolefin concentrically surrounding the inner core 650. In other embodiments, the inner core is surrounded by a plurality of polymer layers that are concentrically coextruded to form a sheath encasing the inner core. In one such embodiment, the water-absorbing layer 652 may comprise at least one layer comprising the water-absorbing polyolefin composition and one or more additional polymer layers, such as at a polyolefin base layer.

In some embodiments, powder particles 632, such as super-absorbent polymer and/or another powder (e.g., talc), or another water-absorbing component (e.g., water-blocking tape, water-blocking yarns) may be attached to the outer surface of the central strength member 624. It should be recognized that the presence of the powder particles 632 is optional as the multilayer structure (see, for example, FIGS. 2A-2C) of the tube 602 provides water barrier protection to the contents of the tube 602.

In certain embodiments, the cable 600 is characterized by the absence of powder particles (e.g., SAP or talc).

In some embodiments, the core elements of the cable 600 are stranded (i.e., wound) about the central strength member 624. The core elements may be stranded in a repeating reverse-oscillatory pattern, such as so-called S-Z stranding, or other stranding patterns (e.g., helical). When present, the optional binder film 626 may constrain the core elements in the stranded configuration, facilitating mid-span or cable-end access of the optical fibers 608 and cable bending, without the core elements releasing tension by expanding outward from the access location or a bend in the core 612 of the cable 600.

In other contemplated embodiments, the core elements are non-stranded. In some such embodiments, the core elements include micro-modules or tight-buffered optical fibers that are oriented generally in parallel with one another inside the core 612. For example, harness cables and/or interconnect cables may include a plurality of micro-modules, each including optical fibers and tensile yarn (e.g., aramid). Some such cables may not include a central strength member. Some embodiments, include multiple cores or sub-assemblies and jacketed together in the same carrier/distribution cable.

In certain embodiments, the cable 600 may include one or more ripcords 642 in or adjoining the jacket 634 to help facilitate opening of the jacket 634.

In a further aspect, the disclosure provides embodiments in which a single layer comprising a water-absorbing polyolefin composition is extruded. A single layer of the water-absorbing polyolefin composition may be extruded onto a substrate (directly or indirectly) to form a multilayer structure or extruded to form a shaped article such as a tube having a single layer structure.

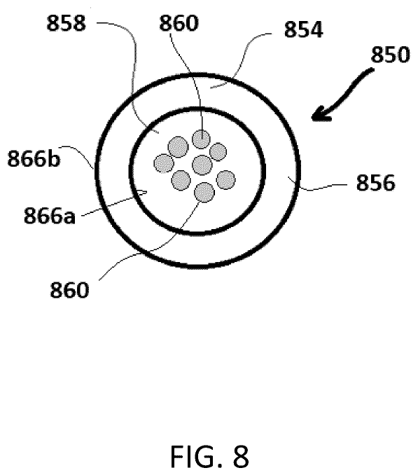

FIG. 8 shows a cross section of a buffer tube for use in fiber optic applications which is broadly designated by reference character 850. Buffer tube comprises a continuous annular shaped sidewall 804 defining a centrally disposed conduit 858, and one or more communication elements 860 disposed within the conduit 858. The annular shaped sidewall 854, central conduit 858, and one or more communication elements each extend continuously along a length of the buffer tube. More specifically, the conduit 858 extends longitudinally along the length of the buffer tube 850.

In certain embodiments, the conduit 858 may comprise one or more communication elements (e.g., one or more optical fiber cores, dielectric insulated wires or wire, and the like) that extend continuously along the length of the conduit. For example, the buffer tube may comprise from 2 to 24, 4 to 16, or 6 to 12 individual communication elements disposed in the conduit 858.

The buffer tube comprises a water-absorbing polyolefin layer 856. In this embodiment, water-absorbing polyolefin layer 856 defines an inner surface 866a and an outer surface 866b of the buffer tube 850.

According to an exemplary embodiment, the one or more communication elements comprise optical fibers, such as a glass optical fiber having a fiber optic core surrounded by a cladding. Some such glass optical fibers may also include one or more polymeric coatings. The optical fiber may comprise single mode optical fibers, multi-mode optical fibers, or a multi-core optical fiber in still other embodiments. The optical fiber may be bend resistant (e.g., bend insensitive optical fiber, such as CLEARCURVE™ optical fiber manufactured by Corning Incorporated of Corning, N.Y.). The optical fibers may be color-coated and/or tight-buffered. The optical fibers may be one of several optical fibers aligned and bound together in a fiber ribbon form.

As in the embodiment described with respect to FIG. 3, the individual communication elements (e.g., optical fiber) may include a water absorbing polyolefin layer concentrically surrounding each individual communication element in addition to a buffer tube 850 comprising the water absorbing polyolefin layer.

In other contemplated embodiments, the core elements may also or alternatively include straight or stranded conductive wires (e.g., copper or aluminum wires) or other elements. In some embodiments, the core elements are all about the same size and cross-sectional shape, such as all being round and having diameters of within 10% of the diameter of the largest of the core elements. In other embodiments, core elements may vary in size and/or shape.

As in the previously discussed embodiments, the water-absorbing polyolefin composition comprises a polymeric blend of a polyolefin polymer and a micronized super absorbent polymer particles. Suitable polyolefin polymers are discussed previously.

In certain embodiments, any super absorbent polymer that is capable of being micronized and does not degrade under extrusion conditions may be used in the polymeric blend comprising the super absorbent polymer (SAP) and the polyolefin polymer.

Advantageously, the polymeric blend of the water-absorbing polymer layer is cable of being melt extruded to form the water-absorbing layer. In certain embodiments, the water-absorbing polyolefin composition may be melt extruded concentrically surrounding one or more communication elements to form a buffer tube.

In certain embodiments, the polyolefin and the micronized super absorbent polymer particles of the water-absorbing polyolefin layer are preblended to form a homogeneous blend that is then extruded to form a buffer tube comprising the water-absorbing polyolefin layer. In other embodiments, the micronized super absorbent polymer particles are separately added to the extruder, which is then melt extruded to form a polymeric blend comprising the micronized super absorbent polymer particles and the polyolefin. The micronized super absorbent polymer particles may be homogeneously or heterogeneously blended with the polyolefin. In certain embodiments, the micronized super absorbent polymer particles and polyolefin are homogenously blended.

In certain embodiments, the super absorbent polymer (SAP) comprises an acrylic acid copolymer having high water absorbency and retention properties. For example, the SAP particles may have a water absorbency of at least 300 g/g (measured in accordance with JIS K 7223), and in particular, at least 400 g/g, and more particularly 500 g/g, and even more particularly, at least 600 g/g, such as at least 650 g/g, at least 700 g/g, at least 750 g/g, and at least 800 g/g.

Examples of suitable SAP particles that may be used in certain embodiments of the invention include salts (e.g., Na, K, NH₃) of cross-linked acrylic acid polymer and starch acrylic acid graft copolymers. In certain embodiments, the SAP comprises an acrylate styrene copolymer. A commercially available SAP is available from Sanyo Chemical Industries under the product name SANFRESH (product code ST 500D). A further example of a commercially available SAP is available from SUMITOMO SEIKA under the product name AQUA KEEP (product code CA 180N).

In certain embodiments, the micronized super absorbent polymer (SAP) comprises a plurality of particles having an average particle diameter greater than 20 μm, and in particular, greater than 50 μm, and more particularly, greater than 60 μm, and even more particularly, greater than 65 μm. In certain embodiments, the SAP particles have an average particle diameter ranging from about 20 to 550 μm, and in particular, from about 30 to 450 μm, and more particularly, from about 45 to 400 μm. In some embodiments, the SAP particles have an average particle diameter ranging from about 50 to 390 μm. In particular, embodiments, the SAP particles have an average particle diameter ranging from about 20 to 100 μm, and in particular, from about 30 to 90 μm, and more particularly from about 50 to 80 μm.

Unless otherwise indicated, particle sizes and particle size distribution may be measured in accordance with ASTM E3340-22 with a Microtrac 3500.

In certain embodiments, the micronized super absorbent polymer (SAP) comprises a plurality of particles having an average particle diameter greater than 200 μm, and in particular, greater than 250 μm, and more particularly, greater than 300 μm, and even more particularly, greater than 350 μm. In certain embodiments, the SAP particles have an average particle diameter ranging from about 250 to 550 μm, and in particular, from about 300 to 450 μm, and more particularly, from about 350 to 400 μm. In some embodiments, the SAP particles have an average particle diameter ranging from about 370 to 390 μm.

In one embodiment, the SAP particles have an average particle diameter of at least 250 μm, at least 260 μm, at least 270 μm, at least 275 μm, at least 280 μm, at least 290 μm, at least 300 μm, at least 310 μm, at least 320 μm, at least 330 μm, at least 340 μm, at least 350 μm, at least 360 μm, at least 370 μm, at least 380 μm, at least 390 μm, at least 400 μm, at least 410 μm, at least 420 μm, at least 430 μm, at least 440 μm, at least 450 μm, at least 460 μm, at least 470 μm, at least 480 μm, at least 490 μm, at least 500 μm, at least 510 μm, at least 520 μm, at least 530 μm, at least 540 μm.

In addition, the SAP particles may have an average particle diameter of less than 550 μm, less than 540 μm, less than 530 μm, less than 520 μm, less than 510 μm, less than 500 μm, less than 490 μm, less than 480 μm, less than 470 μm, less than 460 μm, less than 450 μm, less than 440 μm, less than 430 μm, less than 420 μm, less than 410 μm, less than 400 μm, less than 390 μm, less than 380 μm, less than 370 μm, less than 360 μm, less than 350 μm, less than 340 μm, less than 330 μm, less than 320 μm, less than 310 μm, less than 300 μm, less than 290 μm, less than 280 μm, less than 270 rows, and less than 260 μm.

The polyolefin polymer comprises the major component of the polymer blend. Suitable polyolefins for use in the polymer blend are those discussed above with respect to the polyolefin-based layer.

The amount of the SAP particles in the polymer blend will generally depend on the final desired properties of the multilayer. In general, the amount of the SAP particles may range from about 5.0 weight percent to about 50 weight percent, based on the total weight of the polymer blend, and in particular, from about 5 to 20 weight percent, and more particularly, from about 5 to 10 weight percent, based on the total weight of the polymer blend.

In one embodiment, the amount of the SAP in the polymer blend may be at least about any one of the following: at least 0.05, at least 0.10, at least 0.2, at least 0.3, at least 0.4, at least 0.5, at least 0.6, at least 0.7, at least 0.8, at least 0.9, at least 1.0, at least 2.0, at least 3.0, at least 4.0 at least 5.0, at least 6.0, at least 7.0, at least 8.0, at least 9.0, at least 10.0, at least 11.0 at least 12.0, at least 13.0, at least 14.0, at least 15.0, at least 16.0, at least 17.0, at least 18.0, at least 19.0 and at least 20.0 weight percent, based on the total weight of the polymeric blend. In other embodiments, the amount of the SAP in the blend may be less than about any one of the following: 20.0, 19.0, 18.0, 17.0, 16.0, 15.0, 14.0, 13.0, 12.0, 11.0, 10.0, 9.0, 8.0, 7.0, 6.0, 5.0, 4.0, 3.0, 2.0, 1.0, and less than 0.5, weight percent, based on the total weight of the polymeric blend. It should also be recognized that the amount of the SAP particles present in a polymer blend also encompasses ranges between the aforementioned amounts.

In certain embodiments, the SAP particles may be provided in a masterbatch carrier resin. For example, in one embodiment, the SAP particles are provided in a polyolefin carrier resin that is blended with a polyolefin polymer prior to extruding a layer comprising the polymer blend of the polyolefin and the SAP particles. The masterbatch may also include additional additives, such as those mentioned previously. Alternatively, the SAP particles may be separately metered directly into the polyolefin polymer during the extrusion process.

In certain embodiments, the water-absorbing polyolefin layer may be deposited (e.g., extruded) onto a surface of a substrate. As discussed previously, the substrate may comprise a polymeric material, such as a molded article, a film, a foam sheet, a nonwoven material, or the like, and combinations thereof. In other embodiments, the substrate may comprise a rod shaped (e.g., cylindrical) member having a continuous longitudinal length. Suitable materials for the rod shaped member may include a steel rod, stranded steel, tensile yarn or fibers (e.g., bundled aramid), fiberglass, polymeric based rod, or other similar materials.

Additional aspects of the disclosure are directed to a system and method of preparing polymer pellets comprised of a polymer composition comprising a polyolefin resin and micronized super absorbent polymer.

In certain embodiments, the polymer pellets comprise a blend of one or more polyolefin resins and the micronized super absorbent polymer in which the pellets have an average size ranging from about 1 to 5 mm, and in particular, from about 1.5 to 4.0 mm, and more particularly, from about 2 to 3 mm.

The polymer pellets can be prepared by blending and melt kneading the blend of the polyolefin resin and the micronized super absorbent polymer in an extruder. In certain embodiments, the extruder comprises multiple barrels and the polyolefin resin is introduced into the extruder first where it is subjected to melt kneading, and the micronized super absorbent polymer is introduced into the extruder downstream of where the polyolefin resin is introduced. For example, in an extruder having 7 to 10 barrels, the polyolefin resin may be introduced at the first barrel while the micronized super absorbent polymer is introduced at a downstream barrel (such as, barrels 3, 4, or 5).

The polyolefin resin is melt kneaded with the micronized super absorbent polymer to form a molten or semi-molten polymer stream comprising the polyolefin resin and the micronized super absorbent polymer (the molten or semi-molten polymer stream may include other additives as previously mentioned).

The molten or semi-molten polymer stream is then introduced into a pellet forming die comprising a plurality of fluid channels that are in communication with a die outlet surface of the pellet forming die. As the polymer stream is introduced into the forming die, the polymer stream is distributed into the plurality of fluid channels. Each fluid channel is in communication with an associated extrusion orifice (not shown) formed in the die outlet surface.

For the preparation of conventional sized polymer pellets, it is generally desirable for the extrusion orifices to have diameters ranging from about 1.5 to 5 mm, and in particular, from about 2 to 4 mm, and more particularly, from about 2.5 to 3.0 mm. Pellet size may be measured in accordance ASTM E3340-22 with a Microtrac 3500.

Generally, a distal portion of the pellet forming die is disposed within a water bath so that as the polymer strands are discharged through the extrusion orifices, the pellets are discharged directly into the water bath. Preferably, the distal end of the pellet forming die (the downstream end) is partially submerged in the water bath so that the extrusion orifices are also submerged in the water bath.

The pellets may then be collected, dried, and transferred to a suitable container for later use.

In certain embodiments, the system and method are directed to the preparation of micronized polymer pellets in which the pellets having an average particle size of less than 800 μm. Suitable materials for the polyolefin resin and micronized super absorbent polymer are discussed previously.

In certain embodiments, the disclosure is directed to a bulk mass comprising a plurality of micronized polymer pellets polymer comprises of a first polyolefin resin, and a micronized super absorbent polymer. In certain aspects, the disclosure is directed to a micronized polymer pellet having an average diameter of less than 800 microns (μm).

In further aspects of the disclosure, a bulk mass comprising a plurality of micronized polymer pellets is provided in which the micronized polymer pellets comprise a polyolefin composition having a blend of one or more polyolefin resins (e.g., a first polyolefin resin and a second polyolefin resin), and the micronized super absorbent polymer.

In certain embodiments, the polymeric mass comprising a plurality of micronized polymer pellets exhibit a relatively narrow particle size distribution.

In certain embodiments, the micronized polymer pellets exhibit an average particle size ranging from about 250 to 600 μm, and more particularly, from about 400 to 500 μm, and even more particularly, from about 300 to 400 μm. In certain embodiments, the plurality of micronized polymer pellets exhibit an average particle size of less than 500 μm with a standard deviation of less than 50 μm, and in particular, an average particle size of less than 450 μm with a standard deviation of less than 50 μm.

In certain embodiments, the polymeric mass comprising a plurality of micronized polymer pellets exhibits a D90 of 600 μm and a D10 of 300 μm. In certain embodiments, the plurality of micronized polymer of the disclosure has a substantially narrow particle size distribution. In particular embodiments the 90/10 ratio of particle sizes of the material is from 625-325; from 575-375 or from 500-400.

In a preferred embodiment, the plurality of micronized polymer pellets exhibit an average particle size of 450 μm with 80% of the particles having a particle size preferably within 50 microns of the average particle size, and more preferably within 40 microns of the average particle size. In certain embodiments, the plurality of micronized polymer pellets exhibit an average particle size of 450 μm with 80% of the particles having a particle size preferably within 25 microns of the average particle size.

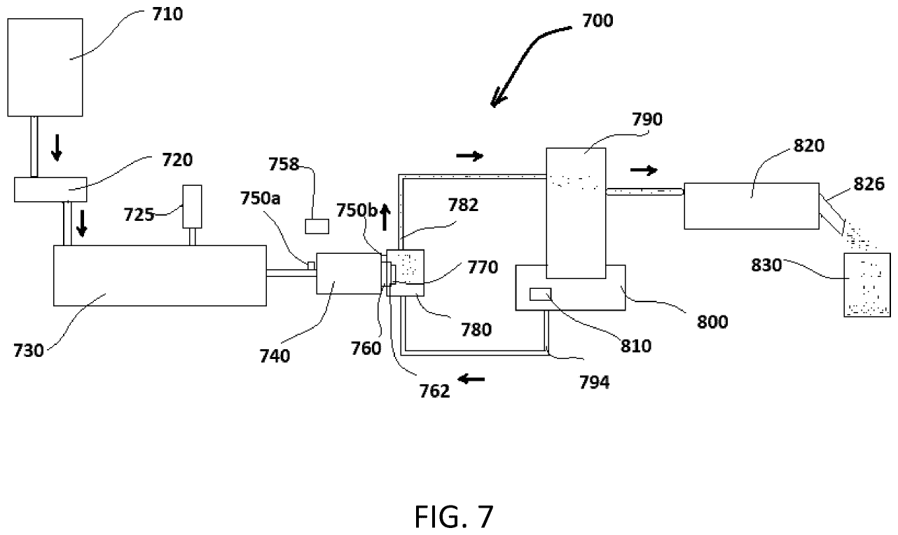

With reference to FIG. 7, an example of a system for preparing micronized polymer pellets is schematically illustrated and broadly designated by reference character 700.

The system 700 includes one or more sources of polymeric and additive components that are blended to form a polymer composition. In the illustrated embodiment, the system includes a high intensity mixer 710 in which the individual components of the polymer composition are introduced and mixed to provide a mixed material comprising a polymer resin. In certain embodiments, each component of the polymer composition is metered into the high intensity mixer and subsequently mixed in batches. In some embodiments, the micronized super absorbent polymer is blended with the polymer resin in the high intensity mixer 710.

In certain embodiments, the micronized super absorbent polymer is provided via source 725 in which the micronized super absorbent polymer is introduced directly into an extruder 730.

Alternatively, the system may be configured to continuously meter in each component of the polymer composition to provide a continuous process of preparing the polymer micropellets. For example, the high intensity mixer may be in communication with one or more sources of polymer (e.g., a first polymer source, a second polymer source, a third polymer source, etc.), a SAP source, and one or more additive sources (e.g., antioxidant source, elastomeric source, UV stabilizer source, antistat agent, etc.), which are configured to continuously introduce the individual components into the high intensity mixer at a desired rate and ratio.

In certain embodiments, the mixed material is then introduced into an optional volumetric feeder 720 disposed downstream of the high intensity mixer. The mixed material is then fed into an extruder 730 downstream of the volumetric feeder. The extruder may be a single or twin extruder, such as an extruder available from Coperion.

In the extruder 730, the components of the polymer composition are heated above the melting point of the polymer resins and melt kneaded to provide a molten or semi-molten polymer stream comprising the polymer composition. For a polyolefin composition, the polymer composition is typically heated to a temperature from about 180 to 210° C.

The stream of semi-molten or molten polymer is then introduced into a melt pump 740. The melt pump is disposed downstream of the extruder and is in fluid communication with the extruder. The melt pump includes a proximal and distal end. The proximal end of the melt pump is disposed upstream and the distal end of the melt pump is disposed downstream. In certain embodiments, the melt pump comprises a high pressure melt pump configured and arranged to adjust the pressure of the polymer stream as it is discharged from the melt pump. Suitable melt pumps are available from PSI and Lewa.

A micropellet forming die 760 is disposed downstream of the melt pump. The micropellet forming die comprises a plurality of fluid channels that are in communication with a die outlet surface 762 of the micropellet forming die 760. As the polymer stream is introduced into the micropellet forming die, the polymer stream is distributed into the plurality of fluid channels. Each fluid channel is in communication with an associated extrusion orifice (not shown) formed in the die outlet surface 762. The number of fluid channels and associated extrusion orifices may range from about 200 to 3000, and in particular, from about 1200 to 2,800, and more particularly, from about 2,000 to 2,400.

Typically, the micropellet forming die 760 is maintained at a higher temperature relative to the temperature of the polymer stream exiting the extruder 730. For example, the micropellet forming die 760 may be maintained at a temperature ranging from about 260 to 360° C.

For the preparation of micronized polymer pellets, it is generally desirable for the extrusion orifices to have diameters ranging from about 0.020 to 0.050 mm, and in particular, from about 0.025 to 0.045 mm, and more particularly, from about 0.034 to 0.038 mm.

As the polymer stream is introduced into the micropellet forming die, the molten polymer is divided and flows into the plurality of fluid channels which form polymer strands. As the polymer strands exit the micropellet forming die, a pelletizer 770 cuts the polymer strands into discrete polymer particles (e.g., micropellets). Suitable pelletizers are available from Gala.

Generally, it has been observed that in order to produce micronized polymer pellets suitable for use in rotomolding applications, it is desirable for the micronized polymer pellets to have average diameters of less than 800 microns with a relatively narrow distribution range. For example, at least 80 percent of the micronized polymer pellets have a particle size within 50 microns of the average particle size for the given batch of micropellets. To achieve this result, the inventors have discovered that the pressure of the polymer stream prior to being introduced into the micropellet forming die should be elevated relative to the pressure of the polymer stream as it exits the extruder. Typically, the pressure of the polymer stream is increased by a factor of at least 2, and more preferably, by a factor ranging from 2 to 5 prior to being introduced into the micropellet forming die. The optimal increase in the pressure of the polymer stream will generally be determined based on the composition of the polymer resin as it may vary depending on the chemistry of the polymer resin.

In certain embodiments, the pressure of the polymer stream is increased by at least a factor of 2.0, at least 2.1, at least 2.2, at least 2.3, at least 2.4, at least 2.5, at least 2.6, at least 2.7, at least 2.8, at least 2.9, at least 3.0, at least 3.1, at least 3.2, at least 3.3, at least 3.4, at least 3.5, at least 3.6, at least 3.7, at least 3.8, at least 3.9, at least 4.0, at least 4.1, at least 4.2, at least 4.3, at least 4.4, at least 4.5, at least 4.6, at least 4.7, at least 4.8, at least 4.9, and at least 5.0 prior to the polymer stream being introduced into the micropellet forming die.

In certain embodiments, the pressure of the polymer stream prior to being introduced into the micropellet die is increased by a factor of no more than 5.0, of no more than 4.9, of no more than 4.8, of no more than 4.7, of no more than, 4.6, of no more than 4.5, of no more than 4.5, of no more than 4.4, of no more than 4.3, of no more than 4.2, of no more than 4.1, of no more than 4.0, of no more than 3.9, of no more than 3.8, of no more than 3.7, of no more than 3.6, of no more than 3.5, of no more than 3.4, of no more than 3.3, of no more than 3.2, of no more than 3.0, of no more than 2.9, of no more than 2.8, of no more than 2.7, of no more than 2.6, of no more than 2.5, of no more than 2.4, of no more than 2.3, of no more than 2.2, of no more than 2.1, and of no more than 2.0.

In certain embodiments, the pressure of the polymer stream exiting the melt pump is increased by a factor ranging from about 2.0 to 5.0, and in particular, from about 2.0 to 3.6, and more particularly, from about 2.4 to 3.0.

To assist in monitoring and adjusting the pressure of the polymer stream exiting the micropellet forming die 760, the system may include one or more pressure transducers. In the illustrated embodiment, the system includes a first pressure transducer 750a that is disposed between the extruder 730 and the melt pump 740, and a second pressure transducer 750b disposed between the melt pump and the micropellet forming die. For example, the second pressure transducer may be positioned within or adjacent to an outlet of the melt pump.

In certain embodiments, the first and second pressure transducers 750a, 750b are in communication with a computer or similar device (e.g., a Programmable Logic Controller (PLC)) 758 that is also in communication with the melt pump 740. The computer (hereinafter referred to simply as the “PLC”) may comprise executable program code to adjust the operational speed of the melt pump to achieve a predetermined pressure threshold.

The connection between the pressure transducers, melt pump, and PLC may be wired or wireless. During operation, the PLC receives pressure data measurements from the transducers and, based on these measurements, provides instructions to the melt pump on whether to accelerate or decrease the operational speed of the melt pump in order to maintain the pressure of the polymer stream at a predetermined pressure threshold for a given polymer composition. The communication between the transducers, the melt pump and the PLC may be continuous so that the pressure of the polymer stream exiting the melt pump exhibits a variance of no more than 3 percent, and preferably, no more than 2 percent.

As discussed previously, the predetermined pressure threshold of the polymer stream prior to being introduced into the micropellet forming die will generally be determined based on the composition of the polymer resin being extruded as it may vary depending on the chemistry of the polymer resin. In certain embodiments, the desired pressure of the polymer stream prior to exiting the micropellet forming die will be input into the PLC by an operator (the predetermined pressure threshold may be determined based on targeted particle size of the micropellets and targeted properties). This may be achieved by manually inputting the desired pressure or by using other means, such as wirelessly communicating the desired pressure. In some embodiments, the PLC will comprise a non-transitory storage medium device having stored files (e.g., executable program code) for various polymer compositions, which will also include associated predetermined pressure threshold ranges for a given polymer composition. In this way, the appropriate predetermined pressure threshold may be selected by selecting the polymer composition that is to be extruded.

Referring back to FIG. 7, a distal portion of the micropellet forming die is disposed within a water bath 780 so that as the polymer strands are discharged through the extrusion orifices, they are discharged directly into the water bath. 780. Preferably, the distal end of the micropellet forming die (the downstream end) is partially submerged in the water bath so that the extrusion orifices are also submerged in the water bath.

In certain embodiments, the water bath 780 comprises a stream of heated water that is introduced into the water bath via fluid conduit 784. Typically, the stream of heated water is heated to a temperature ranging from about 70 to 90° C., and in particular from about 76 to 84° C. The stream of heated water is provided from water source 800. The stream of heated water may be introduced into the water bath 780 at a rate ranging from about 50 to 80 gallons/minute, and in particular from about 55 to 70 gallons/minute.

As the stream of heated water is introduced into the water bath 780, the stream of heated water picks up and collects the recently formed micronized polymer pellets. The stream collectively comprising the heated water and micronized polymer pellets flows out of the water bath 780 via fluid discharge conduit 782. Fluid discharge conduit 782 is in fluid communication with a fluid inlet of a dryer unit 790 at which point the stream comprising the heated water and micronized polymer pellets is introduced into the dryer unit 790. In certain embodiments, the dryer unit comprises a centrifugal dryer.

In the dryer unit (e.g., a centrifugal dryer), the micronized polymer pellets are separated from the water and dried. The water is returned to water source 800. A heater 810 may be disposed in the water source 200 to heat the water to a desired temperature. Alternatively, a water heater may be disposed along fluid conduit between the water source 800 and the water bath 780. In a preferred embodiment, the heated water stream is continuously circulated between the water bath and the water source.

Following separation of the micronized polymer pellets from the water, the micronized polymer pellets may optionally be introduced into a classifier to screen out and separate individual pellets that do not fall within the desired particle size distribution range. Suitable particle classifiers are available from Witte.

Next, the micronized polymer pellets may be discharged from the classifier 820 via outlet 826 and introduced into an appropriate storage container, such as a bag or other container.

### Examples

In the following example, a buffer tube comprising a single layer of water-absorbing polyolefin was evaluated in accordance with the GR-20, Section 6.5.3 through Section 6.5.11 for Fiber Optic cable approved by the Insulated Cable Engineers Association (ICEA) and America National Standards Institute (ANSI).

The buffer tube comprised a blend of polypropylene resin (Ineos N05U-00 Polypropylene Impact Copolymer (MFR 5.5) and 10 weight percent micronized SAP particles. The buffer tube was melt extruded with a cross head die. The buffer tube had a wall thickness of 0.25 millimeters and a diameter of 2.5 millimeters.

The test methods and results are provided in Table 1, below.

TABLE 1
Evaluation methods and results

| Property Evaluated | Test Method | Pass/Fail |
|---|---|---|
| Attenuation | R6-38 | Pass |
| Thermal Cycle | GR20, SEC. 7.24 | Pass |
| Mid Span | ICEA 640, SEC. 7.34 | Pass |
| Crush, Flexing, Impact, and | ICEA 640, SEC. 6.4.1-7.32 | Pass |
| Twist (CFIT) | | |
| Low and High Temp. Cable | ICEA 640, SEC. 6.5.2 | Pass |
| Bend | | |
| Stain | ICEA 640 | Pass |
| Water Penetration | ICEA 640, SEC. 7.28 | Pass |

From the results in Table 1, it is evident that a buffer tube prepared from the water-absorbing polyolefin composition passed the GR-20 industry standard for fiber optic cables.

### SUMMARY OF REPRESENTATIVE EMBODIMENTS

Paragraph 1: In a first aspect, a multilayer structure comprising a polyolefin-based layer and a water-absorbing polyolefin layer is provided.

Paragraph 2: In a further aspect, a multilayer structure according to Paragraph 1, is provided wherein the multilayer structure comprises a film.

Paragraph 3: In a further aspect, a multilayer structure according to paragraph 1, wherein the multilayer structure has a tube like shape is provided.

Paragraph 4: In a further aspect, a multilayer structure according to any one or more of paragraphs 1 to 3, wherein the water-absorbing polyolefin layer comprises super absorbent polymer particles, the super absorbent particles having an average particle size from about 20 to 550 μm is provided.

Paragraph 5: In a further aspect, a multilayer structure according to paragraph 4, wherein the super absorbent particles having an average particle size from about 45 to 400 μm is provided.

Paragraph 6: In a further aspect, a multilayer structure according to paragraph 4, wherein the super absorbent particles having an average particle size from about 20 to 100 μm is provided.

Paragraph 7: In a further aspect, a multilayer structure according to any one or more of paragraphs 1 to 6, wherein an amount of super absorbent particles in the water-absorbing polyolefin layer is from about 0.05 to 20 weight percent, based on the total weight of the water-absorbing polyolefin layer is provided.

Paragraph 8: In a further aspect, a multilayer structure according to paragraph 7, wherein an amount of super absorbent particles in the water-absorbing polyolefin layer is from about 2 to 10 weight percent, based on the total weight of the water-absorbing polyolefin layer is provided.

Paragraph 9: In a further aspect, a multilayer structure according to any one or more of paragraphs 1 to 8, wherein a ratio of the thickness of the polyolefin-based layer to a thickness of the water-absorbing polyolefin layer is from 95:5 to 75:25 is provided.

Paragraph 10: In a further aspect, a multilayer structure according to one or more of paragraphs 1 to 9, wherein the polyolefin-based layer and the water-absorbing polyolefin layer comprises a polyolefin selected from the group consisting of polyethylenes (e.g., ultra low density, very low density, low-density, medium density, and high density), polypropylenes, polybutenes, ethylene vinyl acetate, and ethylene propylene copolymers and copolymers, derivatives, and blends thereof is provided.

Paragraph 11: In a further aspect, a multilayer structure according to one or more of the paragraphs 1 to 10, wherein the polyolefin-based layer comprises polypropylene is provided.

Paragraph 12: In a further aspect, a multilayer structure according to one or more of paragraphs 1-11, wherein the water-absorbing polyolefin layer comprises polypropylene is provided.

Paragraph 13: In a further aspect, a multilayer structure of one or more of the paragraphs 1-12, wherein the polyolefin-based layer and the water-absorbing layer comprises the same polyolefin polymer is provided.

Paragraph 14: In yet a further aspect, an optical fiber comprising a fiber optic core, a cladding surrounding the core, and a multilayer structure concentrically surrounding the cladding, the multilayer structure comprising a polyolefin-based layer and a water-absorbing polyolefin layer is provided.

Paragraph 15: In a further aspect, an optical fiber according to paragraph 14, wherein the polyolefin-based layer and the water-absorbing polyolefin layer are coextruded is provided.

Paragraph 16: In a further aspect, an optical fiber according to one or more of paragraphs 14 and 15, wherein the water-absorbing polyolefin layer comprises super absorbent polymer particles, the super absorbent particles having an average particle size from about 20 to 550 μm is provided.

Paragraph 17: In a further aspect, an optical fiber according to paragraph 16, wherein the super absorbent particles having an average particle size from about 45 to 400 μm is provided.

Paragraph 18: In a further aspect, an optical fiber according to paragraph 16, wherein the super absorbent particles having an average particle size from about 20 to 100 μm is provided.

Paragraph 19: In a further aspect, an optical fiber according to any one or more of paragraphs 14 to 18, wherein an amount of super absorbent particles in the water-absorbing polyolefin layer is from about 0.05 to 20 weight percent, based on the total weight of the water-absorbing polyolefin layer is provided.

Paragraph 20: In a further aspect, an optical fiber according to paragraph 19, wherein the amount of super absorbent particles in the water-absorbing polyolefin layer is from about 5 to 10 weight percent, based on the total weight of the water-absorbing polyolefin layer is provided.

Paragraph 21: In a further aspect, an optical fiber according to any one or more of paragraphs 14 to 20, wherein a ratio of the thickness of the polyolefin-based layer to a thickness of the water-absorbing polyolefin layer is from 95:5 to 75:25 is provided.

Paragraph 22: In a further aspect, an optical fiber according to one or more of paragraphs 14 to 21, wherein the polyolefin-based layer and the water-absorbing polyolefin layer comprises a polyolefin selected from the group consisting of polyethylenes (e.g., ultra low density, very low density, low-density, medium density, and high density), polypropylenes, polybutenes, ethylene vinyl acetate, and ethylene propylene copolymers and copolymers, derivatives, and blends thereof is provided.

Paragraph 23: In a further aspect, an optical fiber according to one or more of paragraphs 14 to 22, wherein the polyolefin-based layer comprises polypropylene is provided.

Paragraph 24: In a further aspect, an optical fiber according to one or more of paragraphs 14 to 23, wherein the water-absorbing polyolefin layer comprises polypropylene.

Paragraph 25 In a further aspect, an optical fiber of one or more of paragraphs 14-24, wherein the polyolefin-based layer and the water-absorbing layer comprises the same polyolefin polymer is provided.

Paragraph 26: In a further aspect, an optic fiber cable comprising an outer longitudinally extending jacket defining a core; a buffer tube disposed in said core, the buffer tube comprising a multilayer structure having an annular shape defining a longitudinally extending conduit, the multilayer structure comprising a polyolefin-based layer and a water-absorbing polyolefin layer; and an optical fiber disposed in said conduit is provided.

Paragraph 27: In a further aspect, an optic fiber cable according to paragraph 26, wherein the core comprises a plurality of said buffer tubes disposed therein is provided.

Paragraph 28: In a further aspect, an optic fiber cable according to paragraphs 26 or 27, wherein the polyolefin-based layer and a water-absorbing polyolefin layer of the multilayer structure are coextruded is provided.

Paragraph 29: In a further aspect, an optic fiber cable according to paragraphs 26 or 28, wherein the water-absorbing polyolefin layer comprises super absorbent polymer particles, the super absorbent particles having an average particle size from about 20 to 550 μm is provided.

Paragraph 30: In a further aspect, an optic fiber cable according to paragraph 29, wherein the super absorbent particles having an average particle size from about 45 to 400 μm is provided.

Paragraph 31: In a further aspect, an optic fiber cable according to paragraph 29, wherein the super absorbent particles having an average particle size from about 20 to 100 μm is provided.

Paragraph 32: In a further aspect, an optic fiber cable according to any one or more of paragraphs 26 to 31, wherein an amount of super absorbent particles in the water-absorbing polyolefin layer is from about 0.05 to 20 weight percent, based on the total weight of the water-absorbing polyolefin layer is provided.

Paragraph 33: In a further aspect, an optic fiber cable according to paragraph 32, wherein the amount of super absorbent particles in the water-absorbing polyolefin layer is from about 2 to 10 weight percent, based on the total weight of the water-absorbing polyolefin layer is provided.

Paragraph 34: In a further aspect, an optic fiber cable according to any one or more of claims 26 to 33, wherein a ratio of the thickness of the polyolefin-based layer to a thickness of the water-absorbing polyolefin layer of the multilayer structure is from 95:5 to 75:25 is provided.

Paragraph 35: In a further aspect, an optic fiber cable according to one or more of paragraphs 26 to 34, wherein the polyolefin-based layer and the water-absorbing polyolefin layer of the multilayer structure comprises a polyolefin selected from the group consisting of polyethylenes (e.g., ultra low density, very low density, low-density, medium density, and high density), polypropylenes, polybutenes, ethylene vinyl acetate, and ethylene propylene copolymers and copolymers, derivatives, and blends thereof is provided.

Paragraph 36: In a further aspect, an optic fiber cable according to one or more of paragraphs 26 to 35, wherein the polyolefin-based layer of the multilayer structure comprises polypropylene is provided.

Paragraph 37: In a further aspect, an optic fiber cable according to one or more of paragraphs 26 to 35, wherein the water-absorbing polyolefin layer of the multilayer structure comprises polypropylene is provided.

Paragraph 38: In a further aspect, an optic fiber cable of one or more of paragraphs 26 to 37, wherein the polyolefin-based layer and the water-absorbing layer of the multilayer structure comprises the same polyolefin is provided.

Paragraph 39: In a further aspect, an optic fiber cable of one or more of paragraphs 26 to 39, wherein the buffer tube comprises a plurality of optical fibers disposed is said conduit is provided.

Paragraph 40: In a further aspect, an optic fiber cable according to paragraph 38, wherein the buffer tube comprises from 2 to 20 optical fibers disposed in said conduit is provided.

Paragraph 41: In a further aspect, an optic fiber cable of paragraph 26, wherein the optical fiber comprises a fiber optic core, a cladding surrounding the core, and a multilayer structure concentrically surrounding the cladding, the multilayer structure of the optical fiber comprising a polyolefin-based layer and a water-absorbing polyolefin layer is provided.

Paragraph 42: In a further aspect, an optic fiber cable of paragraph 41, wherein the polyolefin-based layer and a water-absorbing polyolefin layer of the multilayer structure of the optical fiber are coextruded, and wherein the water-absorbing polyolefin layer comprises super absorbent polymer particles, the super absorbent particles having an average particle size from about 20 to 550 μm is provided.

Paragraph 43: In a further aspect, an optic fiber cable according to paragraph 29, wherein the super absorbent particles of the water-absorbing polymer of the optical fiber have an average particle size from about 45 to 400 μm is provided.

Paragraph 44: In a further aspect, an optic fiber cable according to any one or more of paragraphs 41 to 43, wherein a ratio of the thickness of the polyolefin-based layer of the optical fiber to a thickness of the water-absorbing polyolefin layer of the of the optical fiber is from 95:5 to 75:25 is provided.

Paragraph 45: In a further aspect, an optic fiber cable according to any one or more of paragraphs 41 to 44, wherein the polyolefin-based layer of the optical fiber has a thickness from about 70 to 190 μm, and the water-absorbing polyolefin layer of the of the optical fiber has a thickness that is from 35 to 120 μm is provided.

Paragraph 46: In certain aspects a method of preparing a micronized polymer pellets is provided, the method comprising the steps of:
mixing a polymer resin and a plurality of particles comprising a micronized super absorbent polymer to form a homogeneous polymer mixture;
introducing the polymer mixture into an extruder;
melting and kneading the polymer mixture in the extruder to form a molten or semi-molten polymer stream;
introducing the polymer stream into a melt pump;
measuring the pressure of the polymer stream exiting the melt pump;
adjusting the pressure of the polymer stream as it exits the melt pump to a predetermined pressure threshold for the polymer stream;
introducing the polymer stream into a pellet die, said pellet die comprising a plurality of fluid channels and corresponding extrusion orifices, the extrusion orifices having diameters ranging from about 0.020 to 0.050 mm;
dividing the polymer stream to flow through the plurality of fluid channels to form a plurality of polymer strands;
extruding the plurality of polymer strands through said extrusion orifices,
cutting the plurality of polymer strands to form a plurality of micronized polymer pellets; and
drying and collecting the micronized polymer pellets.

Paragraph 47: In certain aspects a method of paragraph 46, wherein the micronized polymer pellets have an average particle size of about 300 to 500 μm, and in particular, from about 300 to 400 μm with a standard deviation of less than 25 μm is provided.

Paragraph 48: In certain aspects a method according to paragraph 46, wherein the step of adjusting the pressure of the polymer stream comprises measuring a pressure of the polymer stream prior to introducing the polymer stream into the melt pump and then adjusting an operational speed of the melt pump to increase the pressure of the polymer stream to the predetermined pressure threshold is provided.

Paragraph 49: In certain aspects a method according to paragraph 46, wherein the predetermined pressure threshold is stored in a computer having a memory device comprising executable program code, the executable program code being configured to instruct the melt pump to adjust the operational speed of the melt pump to achieve the predetermined pressure threshold for the polymer stream is provided.

Paragraph 50: In certain aspects a method according to any one or more of paragraphs 46-49, wherein the step of cutting the plurality of polymer strands to form a plurality of micronized polymer pellets is performed within a water bath, the water bath comprising a stream of heated water that is heated to a temperature ranging from about 70 to 90° C. is provided.

Paragraph 51: In certain aspects a method according to paragraph 50, wherein the steam of heated water collects the plurality of micronized polymer pellets and carries the plurality of micronized polymer pellets to a dryer unit is provided.

Paragraph 52: In certain aspects a method according to one or more of paragraphs 46 to 51, wherein the polymer resin comprises a polyolefin is provided.

Paragraph 53: In certain aspects a method according to paragraph 52, wherein the polyolefin is selected from polyethylene, polypropylene, and blends thereof is provided.

Paragraph 54: In certain aspects a method according to paragraph 53, wherein the polyolefin is selected from the group consisting of linear low density polyethylene (LLDPE), low density polyethylene (LDPE), (mid density polyethylene (MDPE) and high density polyethylene (HDPE), and blends thereof is provided.

Paragraph 55: In certain aspects a method according to paragraph 54, wherein the polymer resin comprises a blend of a LLDPE and a HDPE.

Paragraph 56: a method according to one or more of paragraphs 46 to 52, wherein the polymer resin comprises a polypropylene is provided.

Paragraph 57: In certain aspects a method according to one or more of paragraphs 46 to 56, wherein further comprising one or more of an antioxidant, a styrene containing elastomer, and a UV stabilizer is provided.

Paragraph 58: In certain aspects a method according to any one or more of paragraphs 46 to 57, wherein the step of adjusting the pressure of the polymer stream comprises increasing the pressure of the polymer stream by a factor at least 2 is provided.

Paragraph 59: a method according to any one or more of paragraphs 46 to 58, wherein the step of adjusting the pressure of the polymer stream comprises increasing the pressure of the polymer stream by a factor ranging from 2 to 5 is provided.

Paragraph 60: In certain aspects a system for preparing micronized polymer pellets having water absorbing properties is provided, the system comprising
a source of a polymer resin and a source of micronized super absorbent polymer particles;
an extruder in communication with the source of the polymer resin and the source of the micronized super absorbent polymer particles, the extruder being configured and arranged to melt knead the polymer resin and micronized super absorbent polymer particles to form a molten or semi-molten polymer stream;
a melt pump disposed downstream of the extruder and in fluid communication with the extruder, the melt pump having a proximal and distal end, the melt pump being configured to receive the polymer stream from the extruder and adjust a pressure of the polymer stream to a predetermined pressure threshold;
a die disposed downstream of the melt pump, the die comprising a plurality of fluid channels and a plurality of extrusion orifices each associated with a corresponding fluid channel, wherein the die is configured and arrange to distribute the polymer stream into a plurality of polymer strands; and
a pelletizer disposed downstream of the die, the pelletizer configured and arranged to cut the polymer strands to form a plurality of micronized polymer pellets.

Paragraph 61: In certain aspects a system according to paragraph 60, further comprising a pressure transducer disposed adjacent the distal end of the melt pump, the pressure transducer being configured and arranged to measure a pressure of the polymer stream as it exits the melt pump is provided.

Paragraph 62: In certain aspects a system of paragraph 61, further comprising a computer in communication with the pressure transducer and the melt pump, the computer comprising executable program code for providing instructions to the melt pump to increase or decrease operational speed of the melt pump to adjust the pressure of the polymer melt to the predetermined threshold is provided.

Paragraph 63: In certain aspects a system of one or more of paragraphs 60 to 62, further comprising a water bath and wherein the extrusion orifices of the die are submerged in the water bath is provided.

Paragraph 64: In certain aspects a system of paragraph 63, wherein the water bath comprises a heated water stream having a temperature from about 70 to 90° C., and wherein said heated water stream is in fluid communication with a dryer unit disposed downstream of the dryer unit, wherein the heated water stream collects the micronized polymer pellets in the water bath and transports them to the dryer unit is provided.

Paragraph 65: In certain aspects a buffer tube comprising a longitudinally extending side wall defining a longitudinally extending inner conduit, and wherein the buffer tube comprises a water-absorbing polyolefin composition is provided.

Paragraph 66: In certain aspects a buffer tube according to paragraph 65, wherein the water-absorbing polyolefin composition comprises super absorbent polymer particles, the super absorbent particles having an average particle size from about 20 to 550 μm is provided.

Paragraph 67: In certain aspects a buffer tube according to paragraph 66, wherein the super absorbent particles having an average particle size from about 45 to 400 μm is provided.

Paragraph 68: In certain aspects a buffer tube according to paragraph 66, wherein the super absorbent particles having an average particle size from about 20 to 100 μm is provided.

Paragraph 69: In certain aspects a buffer tube according to one or more of paragraphs 66-68, wherein an amount of super absorbent particles in the water-absorbing polyolefin composition is from about 0.05 to 20 weight percent, based on the total weight of the water-absorbing polyolefin composition is provided.

Paragraph 70: In certain aspects a buffer tube according to paragraph 69, wherein an amount of super absorbent particles in the water-absorbing polyolefin composition is from about 2 to 10 weight percent, based on the total weight of the water-absorbing polyolefin composition is provided.

Paragraph 71: In certain aspects a buffer tube according to one or more of paragraphs 65-70, wherein one or more communication elements are disposed in the inner conduit is provided.

Paragraph 72: In certain aspects a buffer tube according to paragraph 71, wherein the one or more communication elements comprise an optical fiber is provided.

Paragraph 73: In certain aspects a buffer tube according to one or more of paragraphs 65 to 72, wherein the polyolefin selected from the group consisting of polyethylenes (e.g., ultra low density, very low density, low-density, medium density, and high density), polypropylenes, polybutenes, ethylene vinyl acetate, and ethylene propylene copolymers and copolymers, derivatives, and blends thereof is provided.

Paragraph 74: In certain aspects a buffer tube according to one or more of paragraphs 65-73, wherein the polyolefin of the water-absorbing polyolefin composition comprises polypropylene is provided

Paragraph 75: In certain aspects a optic fiber cable comprising an outer longitudinally extending jacket defining a core; one or more buffer tubes disposed in said core, and a longitudinally extending strength member disposed in said core, said strength member comprising an inner core and a layer of a water-absorbing polyolefin composition concentrically surrounding the inner core is provided.

Paragraph 76: In certain aspects a optic fiber cable of paragraph 75, wherein the inner core is selected from the group consisting of a glass-reinforced composite rod, a steel rod, stranded steel, tensile yarn or fibers, fiberglass, and combinations thereof is provided

Paragraph 77: In certain aspects an optic fiber cable of paragraph 75, wherein the water-absorbing polyolefin composition comprises super absorbent polymer particles, the super absorbent particles having an average particle size from about 20 to 550 μm is provided.

Paragraph 78: In certain aspects an optic fiber cable of paragraph 78, wherein the super absorbent particles having an average particle size from about 45 to 400 μm is provided.

Paragraph 79: In certain aspects an optic fiber cable of paragraph 77, wherein the super absorbent particles having an average particle size from about 20 to 100 μm is provided.

Paragraph 80: In certain aspects an optic fiber cable of paragraphs 77-79, wherein an amount of super absorbent particles in the water-absorbing polyolefin composition is from about 0.05 to 20 weight percent, based on the total weight of the water-absorbing polyolefin composition is provided.

Paragraph 81: In certain aspects an optic fiber cable of paragraph 80, wherein an amount of super absorbent particles in the water-absorbing polyolefin composition is from about 2 to 10 weight percent, based on the total weight of the water-absorbing polyolefin composition is provided.

Paragraph 82: In certain aspects an optic fiber cable of paragraph 75, wherein one or more communication elements are disposed in said buffer tube is provided.

Paragraph 83: In certain aspects an optic fiber cable according to paragraph 82, wherein the one or more communication elements comprise an optical fiber is provided.

Paragraph 84: In certain aspects an buffer tube according to one or more of paragraphs 75 to 83, wherein the polyolefin selected from the group consisting of polyethylenes (e.g., ultra low density, very low density, low-density, medium density, and high density), polypropylenes, polybutenes, ethylene vinyl acetate, and ethylene propylene copolymers and copolymers, derivatives, and blends thereof is provided.

Paragraph 85: In certain aspects an optic fiber cable according to one or more of paragraphs 75-84, wherein the polyolefin of the water-absorbing polyolefin composition comprises polypropylene is provided.

Paragraph 86: In certain aspects an optic fiber cable according to one or more of paragraphs 75-84, wherein the buffer tube has an annular shaped sidewall defining a longitudinally extending conduit, the annular shaped side wall comprising said water-absorbing polyolefin composition; and an optical fiber disposed in said conduit is provided.

Modifications of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A multilayer structure comprising a polyolefin-based layer and a water-absorbing polyolefin layer.

2. The multilayer structure according to claim 1, wherein the water-absorbing polyolefin layer comprises super absorbent polymer particles, the super absorbent particles having an average particle size selected from the group consisting of from about 20 to 550 μm, from about 45 to 400 μm, and 50 to 390 μm.

3. The multilayer structure according to claim 1, wherein an amount of super absorbent particles in the water-absorbing polyolefin layer is from about 0.05 to 20 weight percent, based on the total weight of the water-absorbing polyolefin layer.

4. The multilayer structure according to claim 3, wherein an amount of super absorbent particles in the water-absorbing polyolefin layer is from about 2 to 10 weight percent, based on the total weight of the water-absorbing polyolefin layer.

5. The multilayer structure according to claim 1, wherein a ratio of the thickness of the polyolefin-based layer to a thickness of the water-absorbing polyolefin layer is from 95:5 to 75:25.

6. The multilayer structure according to claim 1, wherein the polyolefin-based layer and the water-absorbing polyolefin layer comprises a polyolefin selected from the group consisting of polyethylenes (e.g., ultra low density, very low density, low-density, medium density, and high density), polypropylenes, polybutenes, ethylene vinyl acetate, and ethylene propylene copolymers and copolymers, derivatives, and blends thereof.

7. The multilayer structure according to claim 1, wherein the polyolefin-based layer comprises polypropylene, and the water-absorbing polyolefin layer comprises polypropylene.

8. A buffer tube comprising a longitudinally extending side wall defining a longitudinally extending inner conduit, and wherein the buffer tube comprises a water-absorbing polyolefin composition.

9. The buffer tube according to claim 8, wherein the water-absorbing polyolefin composition comprises super absorbent polymer particles, the super absorbent particles having an average particle size selected the group consisting of from about 20 to 550 μm; from about 45 to 400 μm; and from about 20 to 100 μm.

10. The buffer tube according to claim 8, wherein an amount of super absorbent particles in the water-absorbing polyolefin composition is from about 0.05 to 20 weight percent, based on the total weight of the water-absorbing polyolefin composition.

11. The buffer tube according to claim 8, wherein one or more communication elements are disposed in the inner conduit, and wherein the one or more communication elements comprise an optical fiber.

12. An optical fiber comprising a fiber optic core, a cladding surrounding the core, and a multilayer structure concentrically surrounding the cladding, the multilayer structure comprising a polyolefin-based layer and a water-absorbing polyolefin layer.

13. The optical fiber according to claim 12, wherein the polyolefin-based layer and the water-absorbing polyolefin layer are coextruded, and wherein the water-absorbing polyolefin layer comprises super absorbent polymer particles, the super absorbent particles having an average particle size selected from the group consisting of from about 20 to 550 μm; 45 to 400 μm; and from about 20 to 100 μm.

14. The optical fiber according to claim 13, wherein an amount of super absorbent particles in the water-absorbing polyolefin layer is from about 0.05 to 20 weight percent, based on the total weight of the water-absorbing polyolefin layer, and a ratio of the thickness of the polyolefin-based layer to a thickness of the water-absorbing polyolefin layer is from 95:5 to 75:25.

15. The optical fiber according to claim 13, wherein the polyolefin-based layer and the water-absorbing polyolefin layer comprises a polyolefin selected from the group consisting of polyethylenes (e.g., ultra low density, very low density, low-density, medium density, and high density), polypropylenes, polybutenes, ethylene vinyl acetate, and ethylene propylene copolymers and copolymers, derivatives, and blends thereof.

16. An optic fiber cable comprising an outer longitudinally extending jacket defining a core; a buffer tube disposed in said core, the buffer tube comprising the multilayer structure according to claim 12, the buffer tube having an annular shape defining a longitudinally extending conduit, and wherein an optical fiber disposed in said conduit.

17. The optic fiber cable according to claim 16, wherein the core comprises a plurality of said buffer tubes disposed therein.

18. A method of preparing a micronized polymer pellets comprising the steps of:
mixing a polymer resin and a plurality of particles comprising a micronized super absorbent polymer to form a homogeneous polymer mixture;
introducing the polymer mixture into an extruder;
melting and kneading the polymer mixture in the extruder to form a molten or semi-molten polymer stream;
introducing the polymer stream into a melt pump;
measuring the pressure of the polymer stream exiting the melt pump;
adjusting the pressure of the polymer stream as it exits the melt pump to a predetermined pressure threshold for the polymer stream;
introducing the polymer stream into a pellet die, said pellet die comprising a plurality of fluid channels and corresponding extrusion orifices, the extrusion orifices having diameters ranging from about 0.020 to 0.050 mm;
dividing the polymer stream to flow through the plurality of fluid channels to form a plurality of polymer strands;
extruding the plurality of polymer strands through said extrusion orifices,
cutting the plurality of polymer strands to form a plurality of micronized polymer pellets; and
drying and collecting the micronized polymer pellets.

19. The method of claim 18, wherein the micronized polymer pellets have an average particle size of about 300 to 500 μm, and in particular, from about 300 to 400 μm with a standard deviation of less than 25 μm.

20. The method according to claim 18, wherein the step of adjusting the pressure of the polymer stream comprises measuring a pressure of the polymer stream prior to introducing the polymer stream into the melt pump and then adjusting an operational speed of the melt pump to increase the pressure of the polymer stream to the predetermined pressure threshold, and wherein the predetermined pressure threshold is stored in a computer having a memory device comprising executable program code, the executable program code being configured to instruct the melt pump to adjust the operational speed of the melt pump to achieve the predetermined pressure threshold for the polymer stream.
